(19) United States
(12) Patent Application Publication
(10) Pub. No.: US 2025/0299463 A1
(43) Pub. Date: Sep. 25, 2025

(54) SEGMENTATION-ASSISTED DETECTION AND TRACKING OF OBJECTS OR FEATURES

(71) Applicant: NVIDIA Corporation, Santa Clara, CA (US)

(72) Inventors: Joonhwa Shin, Santa Clara, CA (US); Fangyu Li, San Jose, CA (US)

(21) Appl. No.: 18/827,405

(22) Filed: Sep. 6, 2024

Related U.S. Application Data
(60) Provisional application No. 63/567,931, filed on Mar. 20, 2024.

(51) Int. Cl. G06V 10/26

(52) U.S. Cl. CPC G06V 10/26; G06V 2201/07

(57) ABSTRACT

Disclosed are apparatuses, systems, and techniques for segmentation-assisted detection and tracking of objects or features in videos, across images, and/or in other 2D and/or 3D visual content. The techniques include processing a plurality of frames of a video to obtain a plurality of representations of an object depicted in the video. A first subset of the plurality of representations is obtained by processing, using an object detection model, a first subset of the plurality of frames. A second subset of the plurality of representations is obtained using visual similarity of an appearance of the object in a second subset of the plurality of frames to the appearance of the object in at least one other frame of the plurality of frames. The techniques further include obtaining, using the plurality of representations, segmentation masks for the plurality of frames and performing one or more operations based on the segmentation masks.

### RELATED APPLICATIONS

This application claims the benefit of U.S. Provisional Patent Application No. 63/567,931, filed Mar. 20, 2024, entitled “Efficient Spatial Grounding for Vision-Language Model,” the contents of which are incorporated by reference in their entirety herein.

### TECHNICAL FIELD

At least one embodiment pertains to identification of content using artificial intelligence (AI) systems. For example, at least one embodiment pertains to AI systems and techniques for efficient identification and tracking of objects or features in visual content.

### BACKGROUND

Computer vision (CV) automates tasks conventionally performed by human observers. For example, CV models can detect objects or features in images by identifying distinct features in appearances of those individual objects and using the identified features to distinguish objects from the background, from other objects, artifacts, and the like. CV models can process a series of related images (video frames), identify changing locations of various objects, and track motion of the objects. As objects change their size and appearance (and, often, shape) in the course of their motion, the CV models have to ensure that the same objects are consistently tracked across different frames. Vision language models (VLMs) can use understanding of human language and learned associations between visual appearances of objects and their text descriptions to generate natural language descriptions of videos. Such descriptions can include identifications of individual objects, characterization of motion of the objects, nature of the objects, types of interactions between objects, as well as understanding the context and substance of the scene (e.g., traffic accident or hazardous condition occurring, crime being committed), and so on.

### BRIEF DESCRIPTION OF DRAWINGS

FIG. 1 is a block diagram of an example computer architecture capable of performing segmentation-assisted detection and tracking of objects or features, according to at least one embodiment;

FIG. 2 illustrates an example computing device that supports deployment of systems capable of performing segmentation-assisted detection and tracking of objects or features, according to at least one embodiment;

FIGS. 3A-3C illustrate an example data flow of segmentation-assisted detection and tracking of objects or features, according to at least one embodiment; FIG. 3A illustrates an example processing of an initial reference frame using segmentation-based tracking, according to at least one embodiment; FIG. 3B illustrates an example processing of non-reference frames using segmentation-based tracking, according to at least one embodiment; FIG. 3C illustrates an example processing of reference frames using multiple models as part of segmentation-based tracking, according to at least one embodiment;

FIG. 4A illustrates a bounding box for a car identified by an object detection model of FIG. 3A, according to at least one embodiment;

FIG. 4B illustrates a segmentation mask generated based on the bounding box of the car of FIG. 4A using a segmentation model of FIG. 3A, according to at least one embodiment;

FIG. 4C illustrates an annotation generated using the segmentation mask of FIG. 4B, according to at least one embodiment;

FIGS. 4D-4E illustrate schematically a pair of frames that depict multiple objects annotated with object outlines, according to at least one embodiment;

FIG. 5 illustrates example operations of an occluded object identification module that identifies and maintains tracks of temporarily occluded objects or features as part of segmentation-assisted detection and tracking of objects or features, according to at least one embodiment;

FIGS. 6A-6B depict flow diagrams of an example method of segmentation-assisted detection and tracking of objects or features, according to at least one embodiment;

FIG. 7A illustrates inference and/or training logic, according to at least one embodiment;

FIG. 7B illustrates inference and/or training logic, according to at least one embodiment;

FIG. 8 illustrates training and deployment of a neural network, according to at least one embodiment;

FIG. 9 is an example data flow diagram for an advanced computing pipeline, according to at least one embodiment;

FIG. 10 is a system diagram for an example system for training, adapting, instantiating and deploying machine learning models in an advanced computing pipeline, according to at least one embodiment;

FIG. 11A is a block diagram of an example generative language model system suitable for use in implementing at least some embodiments of the present disclosure;

FIG. 11B is a block diagram of an example embodiment in which the generative LM includes a transformer encoder-decoder, according to at least one embodiment; and

FIG. 11C is a block diagram of an example embodiment in which the generative LM 1130 includes a decoder-only transformer architecture, according to at least one embodiment;

FIG. 12 is a block diagram of an example computing device suitable for use in implementing some embodiments of the present disclosure; and

FIG. 13 is a block diagram of an example data center suitable for use in implementing some embodiments of the present disclosure.

### DETAILED DESCRIPTION

CV processing of images, videos, 2D and 3D objects or features, etc. finds uses in numerous applications that call for analysis of visual data, e.g., identification and tracking of vehicles, people, animals, features, etc., understanding of actions and events, e.g., sporting actions, gaming actions, occurrences of certain anticipated or unexpected acts and/or conditions, e.g., traffic accidents and road conditions, unsafe or undesired manufacturing conditions, and/or the like. An output of a CV model can include localization of objects or features (e.g., using suitable semantic segmentation techniques), classifications of the objects or features (e.g., among a number of classes learned in training), a degree of confidence in the obtained localizations/classifications, and/or the like. Such outputs can be provided to users and/or used by various downstream systems, e.g., security systems, manufacturing control systems, on-board planners of autonomous vehicles, and/or the like.

An input into a CV model can include a sequence of frames F₀, F₁, F₂, . . . , of a video and an output can include representations of objects in these frames, e.g., bounding boxes or other bounding shapes that encompass regions of the frames associated with individual objects or more detailed segmentation maps that classify pixels of the frames as corresponding to specific objects (or a background). Although primarily described herein as bounding boxes, this is not intended to be limiting, and any 2D or 3D bounding shape may be used without departing from the scope of the present disclosure (e.g., rectangles, squares, polygons, cuboids, etc.).

Outputs of CV models can further include tracks of the objects, e.g., sets of bounding boxes BB₀, BB₁, BB₂, . . . that are determined to correspond to the images of the same object(s) in the corresponding sequential frames. Accurate tracking of the objects—including objects that are temporarily occluded—is important for reliability of CV applications. In some instances, tracking is a multi-stage process. The first stage includes object-level detections, e.g., identification of locations (e.g., bounding boxes) of the objects. CV processing then continues with the second stage that generates pixel-level segmentation maps (masks) for individual bounding boxes, classifying pixels of the boxes as belonging (or not belonging) to the object enclosed by the bounding box. The segmentation maps can provide compact annotations (e.g., boundaries or outlines) for the objects in the frames. The third stage includes associating objects' annotations for frame Fⱼ with the annotations for the same objects in one or more previous frames Fⱼ₋₁, Fⱼ₋₂, etc. Subsequently, objects' annotations can be added to the respective frames to provide a visualization of motion of the objects. Such visualizations can be displayed to a user or forwarded for further processing, e.g., by a VLM that generates natural language descriptions of the content of the video, evaluates the content, identifies occurrences or non-occurrences of certain conditions, and/or the like.

Such multi-stage processing consumes significant computing resources. In particular, the first object-level detection stage typically deploys sophisticated machine learning models, e.g., convolutional neural network models, attention-based models, transformer models, etc., that evaluate visual features of various portions of images in view of the broader context of other portions, evaluate feature maps at multiple scales of resolution while processing feature vectors of large dimensions, and so on. Processing each individual frame of a video using such models comes at a high computational cost. As a result, low-resource devices (e.g., traffic surveillance systems, inexpensive vehicle perception systems, etc.) are often unable to deliver high-quality live processing of video data.

Aspects and embodiments of the present disclosure address these and other challenges of the computer vision technology by providing for systems and techniques of segmentation-based object detection and tracking in processing of video data. In some embodiments, object-level detections, e.g., bounding boxes, may be obtained using an object detection model (ODM) for a sparse set of video frames, e.g., every Nth frame, F₀, F_{N}, F_{2N}, . . . . Object-level detections for the intervening frames, e.g., F₁, F₂, . . . F_{N-1} frames, may be performed using a lightweight model that identifies object detections based on visual associations of a content of previously detected bounding box(es) with depictions in new frame(s). More specifically, following identification of an object's bounding box BB₀ in frame F₀ (or frame F_{N}, F_{2N}, etc.) using an ODM, a segmentation model (SM) may generate a segmentation mask SM₀ for the object that indicates which pixels of the bounding box belong to the object (rather than to the background or other objects or parts of other objects enclosed by the box).

The segmentation mask SM₀ of the object obtained for frame F₀ may be used, together with a new frame (or a portion of new frame) F₁, as an input into a visual association model (VAM) trained to identify a region in frame F₁ having a maximum visual correlation to the object as captured by the segmentation mask SM₀ for frame F₀. This identified region may be used to determine the bounding box BB₁ for frame F₁ in a much more cost-effective way than processing frame F₁ by the ODM. The segmentation model may then perform segmentation of the bounding box BB₁ to obtain a new segmentation mask SM₁. Similar processing may continue for additional frames F₂, F₃, and so on, with the object tracked across the frames using sequentially determined bounding boxes and segmentation masks: . . . →BBⱼ₋₁→SMⱼ₋₁(+Fⱼ)→BBⱼ=>SMⱼ(+Fⱼ₊₁)→BBⱼ₊₁ . . . .

Exclusion of non-object pixels from the segmentation masks SMⱼ may be performed both as part of training of the VAM and inference computations of new videos. Such exclusion facilitates more reliable detection of objects by the VAM, by reducing distractions caused by non-object artifacts, including the instances where a particular object is temporarily occluded (fully or partially) over a number of frames. In such instances, a state of the occluded object may be stored for at least some predetermined time. When the object reappears in the field of view (or when the object's occlusion subsides), the VAM trained and operating using segmentation masks SMⱼ with pixels of other objects/background excluded is capable of more accurate recognition of the reappearing object based on the stored appearance of the object (and further based on the object's motion history).

For additional accuracy of object tracking, a Kalman filter or other similar statistical tracking tools may be used. More specifically, a tracked state of an object Sⱼ for frame Fⱼ may include coordinates of the bounding box and one or more velocities representing the motion of the bounding box (e.g., when dimensions and/or the aspect ratio of the box are changing with time). The state S of the object for frame Fⱼ may be used to estimate a predicted state PSⱼ₊₁ for frame Fⱼ₊₁. The Kalman filter may then take this predicted state together with the location of the bounding box identified by the VAM model (treated as the measured state by Kalman filter) to obtain the updated state Sⱼ₊₁ of the object, Kalman [Sⱼ, PSⱼ₊₁]→Sⱼ₊₁, which may include the new BBⱼ₊₁ for frame Fⱼ₊₁.

The frames processed with the ODM (e.g., frames F_{N}, F_{2N}, etc.) may generate additional bounding box detections. In some embodiments, such detections may be used as true bounding boxes that replace the bounding boxes tracked as part of the state Sⱼ. In some embodiments, the ODM detections may be used as additional inputs into the Kalman filter, e.g., as additional measured states. The ODM detections and VAM detections may be taken with different (empirically set) weights, e.g., with the ODM detections given more weight than the VAM detections.

The advantages of the disclosed techniques include a significant reduction in the amount of processing involved in tracking objects across video frames. The reduction in the processing costs facilitates live processing of videos with the benefits being progressively more enhanced for larger numbers of objects and higher frame rates. The disclosed techniques allow efficient object identification and tracking by systems and devices having limited processing and memory resources.

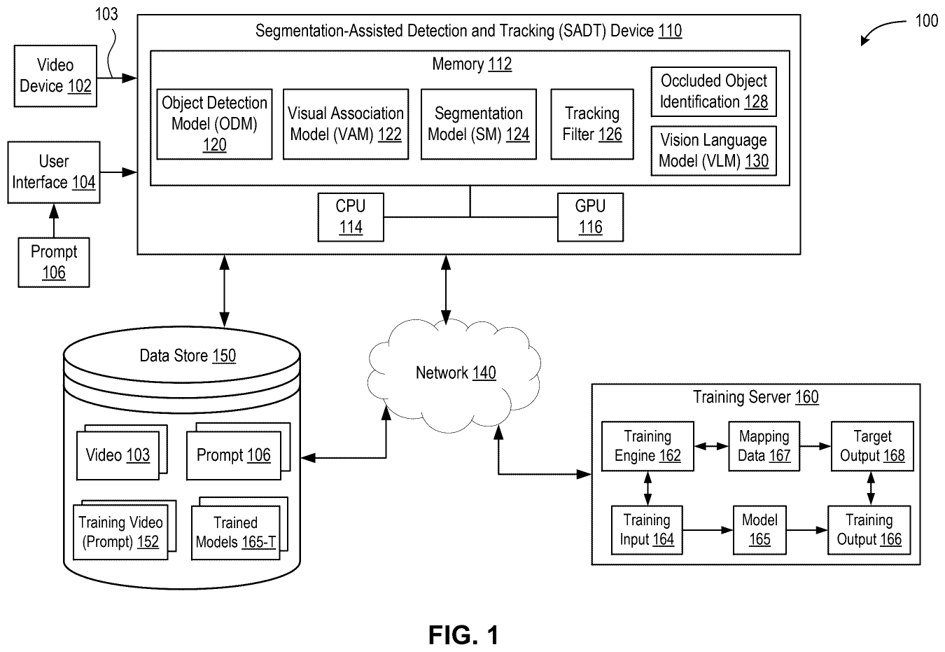

FIG. 1 is a block diagram of an example computer architecture 100 capable of performing segmentation-assisted detection and tracking of objects in videos and other sets of related images, according to at least one embodiment. As depicted in FIG. 1, computer architecture 100 may include a segmentation-assisted detection and tracking (SADT) device 110, a video device 102, a data store 150, and a training server 160, which may be connected via a network 140. Network 140 may be a public network (e.g., the Internet), a private network (e.g., a local area network (LAN), or wide area network (WAN)), a wireless network, a personal area network (PAN), a combination thereof, and/or another network type.

SADT device 110 may be communicatively coupled to a video device 102, which may include any camera, video camera, and/or streaming device capable of generating a series of temporally and/or contextually related images. Video device 102 may include any hardware capable of capturing light, including visible light, infrared light, ultraviolet light, and/or other types of electromagnetic waves (e.g., microwaves, radio waves, etc.). The hardware may include digital camera devices, analog camera devices, light detection and ranging (lidar) sensors, radio detection and ranging (radar) sensors, infrared camera sensors, medical imaging sensors, e.g., magnetic resonance imaging (MRI) sensors, computer tomography (CT) imaging sensors, and/or the like. Video device 102 may further include any suitable software and/or firmware for processing data collected by the hardware to perform image/video encoding, denoising, filtering, enhancement, authentication, serializing, deserializing, and/or other pre-processing or post-processing operations. Video device 102 may output a set of images, referred to as a video 103 herein. Individual images (frames) of video 103 may be associated with timestamps t₀, t₁, t₂, etc. A time interval Δt=t₁−t₀ between adjacent frames may be determined by a frame rate 1/Δt, e.g., 15 frames per second (fps), 30 fps, 60 fps, and/or any other suitable frame rate. Frame rate may correspond to a camera acquisition rate, lidar/radar scanning frequency, and/or the like. In some embodiments, video frames generated by video device 102 may be understandable to a human viewer, e.g., a video captured by a video camera. In other embodiments, video frames generated by video device 102 may be understandable to a human viewer having specialized knowledge (e.g., MRI or CT imaging data). In some embodiments, video frames generated by video device 102 may not be understandable to a human viewer (e.g., lidar imaging data) or may be understandable to a human viewer after substantial pre-processing, reformatting, and/or the like.

SADT device 110 may include a rackmount server, a router computer, a personal computer, a laptop computer, a tablet computer, a desktop computer, a media center, an automotive onboard computer, or any combination thereof. In some embodiments, SADT device 110 may include a smartphone, a wearable device, a virtual/augmented/mixed reality headset or head-up display, a digital avatar or chatbot kiosk, an in-vehicle infotainment computing device, and/or any other suitable computing device capable of performing the techniques described herein. In some embodiments, SADT device 110 may be connected to a user interface 104 that may receive (e.g. from a user, an AI system, or any suitable software) one or more prompts 106 associated with the video. In some embodiments, user interface 104 may include a keyboard or touchpad to capture alphanumeric (e.g., text) inputs of a user, an audio device, e.g., one or more microphones to capture speech inputs by a user, a camera (e.g., a web-camera) to capture a gesture, an image, or a video of a user, and/or the like, or any combination thereof. In some embodiments, text, speech, and/or gesture/image/video input devices may be integrated together (e.g., into a smartphone, tablet computer, desktop computer, and/or the like). In some embodiments, video 103 generated by video device 102 may be processed without an input or a prompt from a user.

Prompt 106, if received, may include a text (e.g., a sequence of one or more typed words), a speech (e.g., a sequence of one or more spoken words), an image or a video, a gesture(s), and/or some combination thereof. Prompt 106 may be generated as part of interaction of a user with SADT device 110. In some embodiments, prompt 106 may be a natural language prompt associated with video 103. Prompt 106 may be in any suitable language. In some embodiments, user interface 104 may translate prompt 106 from one language (e.g., Chinese) to some other language (e.g., English) using one or more automated translation resources. Prompt 106 may include a request for a description (e.g., a textual or audio description) of video 103, a query (question, request, etc.) about a content of video 103, which may be a general query about a nature of a scene depicted in video 103, a question about specific object(s) captured in video 103, a request to perform analytics for video 103, and/or the like. In some embodiments, prior to receiving by SADT device 110, video 103 and/or prompt 106 may be stored in data store 150.

In some embodiments, SADT device 110 may deploy techniques of the instant disclosure to perform segmentation-assisted detection and tracking of objects or features in video 103. In some embodiments, SADT device 110 may perform default processing of video 103 that may be independent of prompt 106, including identifying and tracking any, some, or all objects in video 103. In other embodiments, processing of video 103 by SADT device 110 may be subject to instructions in prompt 106, e.g., a request to track one or more target objects of interest. Objects may include any living entities, e.g., people, animals, organisms, plants, etc. Objects may include any non-living entities including natural things (e.g., rivers, mountains, sun, moon, stars, clouds, etc.), human-made things (e.g., manufactured goods), things naturally produced in a way that is modified by technology (e.g., genetically modified entities), and/or the like. Objects may include any symbols and/or abstractions, e.g., characters, numerals, logos, pictures, artistic expressions, and/or the like. SADT 110 may mark (label, annotate, etc.) detected objects in any suitable form, e.g., using bounding boxes, convex hulls, segmentation maps (masks), etc., that enclose the objects in frames of video 103.

In some embodiments, SADT device 110 may be located on one or more computing devices/servers, e.g., on a cloud-based server. In some embodiments, SADT device 110 may include a memory 112 (e.g., one or more memory devices or units) communicatively coupled to one or more processing devices, such as one or more central processing units (CPU) 114, one or more graphics processing units (GPU) 116, one or more data processing units (DPU), one or more parallel processing units (PPUs), and/or other processing devices (e.g., field-programmable gate arrays (FPGAs), application-specific integrated circuits (ASICs), and/or the like). Memory 112 may include a read-only memory (ROM), a flash memory, a dynamic random-access memory (DRAM), such as synchronous DRAM (SDRAM), a static memory, such as static random-access memory (SRAM), and/or some other memory capable of storing digital data.

Memory 112 may store one or more object detection models (ODMs) 120 trained to detect and/or classify objects in video inputs. ODM 120 may perform processing of a sparse set of reference frames of video 103 to detect locations of objects in, e.g., every Nth frame of video 103. Memory 112 may further store a visual association model (VAM) 122 that identifies locations of objects in non-reference frames using visual similarity of the objects' appearances in neighboring frames, to obviate the need to run ODM 120 for every frame. Locations of objects (e.g., bounding boxes) determined using ODM 120 (for reference frames) or VAM 122 (for non-reference frames and, in some embodiments, also for reference frames) may be processed using a segmentation model (SM) 124 that classifies pixels of various bounding boxes (or other indications of objects' locations) and generates segmentation masks for the corresponding objects. Memory 112 may further store a tracking filter, e.g., Kalman filter, to track and predict locations of various objects across frames of the video. Memory 112 may further store an occluded object identification module 128 to re-identify objects that are temporarily occluded (fully or partially) by other objects or that temporarily depart from and return to the field of view of video 103. Memory 112 may also store a vision language model (VLM) 130 to generate (e.g., responsive to prompt 106) natural language descriptions of various objects, motion of the objects, a type of action performed by the object or in relation to the object, and/or the like.

In some embodiments, VLM 130 (or generally, a multi-modal language model, such as on capable of processing any input modality—including text, image, video, 3D data (such as universal scene descriptor (USD) data), computer aided design (CAD) data, audio data, etc.) may be deployed as part of ODM 120 or in association with ODM 120. For example, VLM 130 may facilitate detection of objects (performed by ODM 120) referenced in prompt 106. In some embodiments, ODM 120 (or VLM 130) may be (or include) an open vocabulary model that uses (e.g., as part of the model's architecture) a language model (LM), which may be a large LM (LLM) having at least 100K of learnable parameters, in some embodiments. The LM may be a model that has been trained in language understanding, e.g., to capture syntax and semantics of human language, e.g., by training to predict a next, a previous, and/or a missing word in a sequence of words (e.g., one or more sentences of a human speech or text). For example, the LM may be trained using training data containing a large number of texts, such as human dialogues, newspaper texts, magazine texts, book texts, web-based texts, and/or any other texts.

Open vocabulary models may be trained to identify specific target content, e.g., as may be named in a prompt in association with an input data (e.g., video 103). For example, in automotive applications, such target content may include cars, trucks, buses, pedestrians, bicyclists, traffic conditions, status of traffic lights, road signs, accidents, and/or other content. Additionally, open vocabulary models may be trained to detect content not encountered in training, e.g., by leveraging the models' language-comprehension abilities learned from a wide variety of texts that include descriptions of numerous content items, including items whose images (or other representations) have not been previously processed by the models.

In some embodiments, any, some, or all of ODM 120, VAM 122, SM 124, and/or VLM 130 may be implemented as a deep learning neural network having multiple layers of linear or non-linear operations, e.g., a convolutional neural network, a recurrent neural network, a fully-connected neural network, a long short-term memory (LSTM) neural network, a neural network with attention, e.g., a transformer neural network, and/or the like, and/or any combination thereof. In at least one embodiment, any, some, or all of ODM 120, VAM 122, SM 124, and/or VLM 130 may include multiple neurons, an individual neuron receiving its input from other neurons and/or from an external source and producing an output by applying an activation function to a combination of inputs modified by (trainable) weights and a bias value. Neurons may be arranged in layers, including an input layer, one or more hidden layers, and/or an output layer. Neurons from adjacent layers may be connected by weighted edges. In some embodiments, any, some, or all of ODM 120, VAM 122, SM 124, and/or VLM 130 may have different architecture, number of neuron layers, number of neurons in various layers, and/or the like.

ODM 120, VAM 122, SM 124, and/or VLM 130 may be trained by training engine 162 hosted by training server 160, which may be (or include) a desktop computer, a laptop computer, a smartphone, a tablet computer, a server, and/or any suitable computing device capable of performing the techniques described herein. Training of the models may be performed using training data that includes videos annotated with ground truth, e.g., correct identifications of various target objects. Training of open vocabulary models may further include zero-shot training where the models are given training prompts to identify objects that have not been encountered in previous training epochs. In some embodiments, visual and/or textual data used for training may be generated using a simulated environment (e.g., NVIDIA's DriveSIM or OMNIVERSE, the METAVERSE, and/or the like) and/or synthetically generated data. Where a simulated environment and/or synthetically generated data is used, ray-tracing or other light transport simulation algorithms may be deployed to increase the realism of the training data generated, and to more accurately represent lighting, shadows, shading, reflections, etc.

During training, predictions of a particular model 165 being trained (e.g., ODM 120, VAM 122, SM 124, and/or VLM 130) may be compared with ground truth annotations. More specifically, training engine 162 may cause a model to process training inputs 164 (including training videos 152, which may be accompanied by training prompts) stored in data store 150 and generate training outputs 166, which represent annotations (identifications) of objects in the corresponding training inputs 164. During training, training engine 162 may also generate mapping data 167 (e.g., metadata) that associates training inputs 164 with correct target outputs 168. Target outputs 168 may include ground truth annotations (identifications) for corresponding training inputs 164. Training causes the model(s) 165 to identify patterns in training inputs 164 based on desired target outputs 168 and learn to accurately classify input data.

Initially, edge parameters (e.g., weights and biases) of the model(s) 165 being trained may be assigned some starting (e.g., random) values. For every training input 164, training engine 162 may compare a training output 166 with the corresponding target output 168. The resulting error or mismatch, e.g., the difference between the desired target output 168 and the generated training output 166 may be back-propagated through the model(s) 165 and at least some parameters of model(s) 165 may be changed in a way that brings the training output 166 closer to the target output 168. Such adjustments may be repeated until the output error for a given training input 164 satisfies a predetermined condition (e.g., falls below a predetermined value). Subsequently, a different training input 164 may be selected, a new training output 166 generated, and a new series of adjustments implemented, until the model is trained to a target degree of accuracy or until the model converges to a limit of its (architecture-determined) performance.

Training server 160 may train any number of models 165 (e.g., ODM 120, VAM 122, SM 124, and/or VLM 130) using suitable sets of training inputs 164 and target outputs 168. Trained models 165-T may be stored in data store 150 and downloaded and deployed on any suitable machine for inference of new data. For example, trained models 165-T deployed on SADT device 110 may include any, some, or all of ODM 120, VAM 122, SM 124, and/or VLM 130. Similarly, trained models 165-T may be deployed on any other device, including any computing device that uses computer vision techniques, e.g., a media-processing device, an on-board computer of an autonomous vehicle, a public or private surveillance system, a traffic control system, an industrial control system, and/or the like.

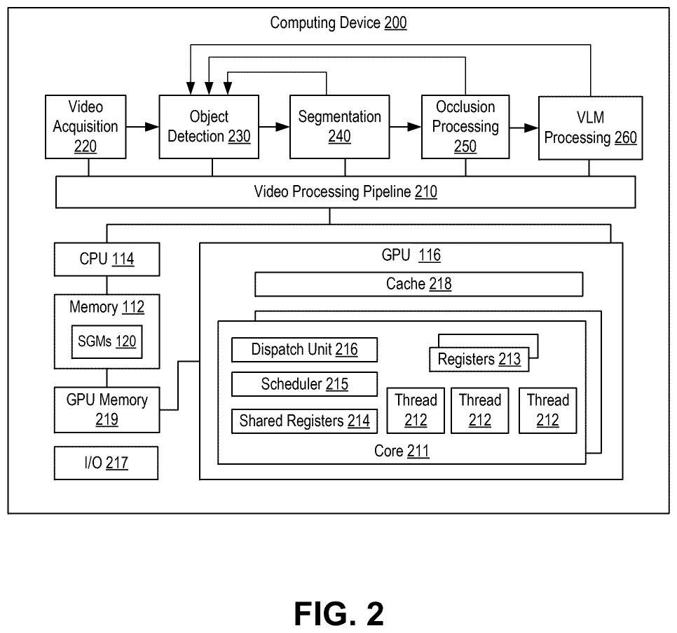

FIG. 2 illustrates an example computing device 200 that supports deployment of systems capable of performing segmentation-assisted detection and tracking of objects or features in videos, other sets of related images, 2D and 3D content, and/or other types of visual content, according to at least one embodiment. In at least one embodiment, computing device 200 may be a part of SADT device 110 (with reference to FIG. 1). In at least one embodiment, computing device 200 may implement a video processing pipeline 210 that detects and tracks objects in video and other sets of related images. Video processing pipeline 210 may include a video acquisition stage 220 that obtains an input video, e.g., by receiving the video from a video device 102 (with reference to FIG. 1), retrieving the video from data store 150, and/or the like. Video acquisition stage 220 may also include receiving one or more prompts associated with the received video(s), e.g., prompt 106 in FIG. 1. Video processing pipeline 210 may further include an object detection stage 230 that deploys one or more CV models (and that may also include one or more VLMs, in some embodiments) to detect objects in individual frames of the video. For example, object detection stage 230 may include ODM 120 and/or VAM 122 of FIG. 1. Video processing pipeline 210 may further include a segmentation stage 240 to perform semantic segmentation of various frame portions associated with the objects identified by object detection stage 230 to perform pixel-level classification of various portions of interest. Segmentation stage 240 may be used to add annotations (e.g., outlines and descriptions) to objects' depictions in the video frames to provide a visual guide to the motion of the objects. As illustrated schematically with the back arrow, segmentation performed for a given frame may be used to inform object detection (e.g., VAM 122) about locations of corresponding objects in other (e.g., subsequent) video frames. The outputs of segmentation stage 240 may be used by an occlusion processing stage 250 to identify and track objects that are temporarily occluded or move outside the field of view. As illustrated schematically with the corresponding back arrow, occluded/departed objects may continue to be monitored by object detection stage 230 for possible reemergence/return to the field of view. Video processing pipeline 210 may also include a VLM processing stage 260. In some embodiments, VLM processing stage 260 may operate on video frames annotated by other stages of video processing pipeline 210 (e.g., segmentation stage 240). In some embodiments, VLM processing stage 260 may be integrated with object detection stage 230. For example, one or more models of VLM processing stage 260 may include an open vocabulary CV model that detects objects in images/videos based on directions in user-generated and/or software-generated prompts. In some embodiments, VLM processing stage 260 may be deployed as part of object detection stage 230 and also as part of the post-processing of the annotated video. For example, a first VLM model, e.g., an open vocabulary model, may be used to detect one or more objects in the video in response to a first natural language prompt enumerated target object of interest in the video. A second VLM model, e.g., an action recognition model, may be used to generate (e.g., in response to the same prompt or an additional prompt) a type of action performed by the target object(s) (or associated with the target object(s)) in the video.

Operations of video acquisition stage 220, object detection stage 230, segmentation stage 240, occlusion processing stage 250, and/or VLM processing stage 260, and/or other software/firmware modules instantiated on computing device 200 may be executed using one or more CPUs 114, one or more GPUs 116, one or more parallel processing units (PPUs) or accelerators, such as a deep learning accelerator, data processing units (DPUs), and/or the like. In at least one embodiment, a GPU 116 includes multiple cores 211. An individual core 211 may be capable of executing multiple threads 212. Individual cores 211 may run multiple threads 212 concurrently (e.g., in parallel). In at least one embodiment, threads 212 may have access to registers 213. Registers 213 may be thread-specific registers with access to a register restricted to a respective thread. Additionally, shared registers 214 may be accessed by one or more (e.g., all) threads of a core 211. In at least one embodiment, individual cores 211 may include a scheduler 215 to distribute computational tasks and processes among different threads 212 of the core. A dispatch unit 216 may implement scheduled tasks on appropriate threads using correct private registers 213 and shared registers 214. Computing device 200 may include input/output component(s) 217 to facilitate exchange of information with one or more users or developers.

In some embodiments, operations of video processing pipeline 210 may be supported by a single GPU 116, e.g., A100 NVIDIA® GPU, or any number (e.g., two, four, five, six, etc.) of GPUs 116. In at least one embodiment, GPU 116 may have a (high-speed) cache 218, access to which may be shared by multiple cores 211. Furthermore, computing device 200 may include a GPU memory 219 where GPU 116 may store intermediate and/or final results (outputs) of various computations performed by GPU 116. After completion of a particular task, GPU 116 (or CPU 114) may move the output to (main) memory 112. In at least one embodiment, CPU 114 may execute processes that involve serial computational tasks whereas GPU 116 may execute tasks (such as multiplication of inputs of a neural node by weights and adding biases) that are amenable to parallel processing.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, generative AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine, an in-vehicle infotainment system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems for performing medical operations, systems for performing factory operations, systems for performing analytics operations, systems for performing medical operations, systems for performing factory operations, systems for performing analytics operations, systems implemented using an edge device, systems for generating or presenting at least one of augmented reality content, virtual reality content, mixed reality content, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implementing one or more language models, such as large language models (LLMs) or visual language models (VLMs) that may process text, voice, image, and/or other data types to generate outputs in one or more formats, systems implemented at least partially using cloud computing resources, systems for performing generative AI operations, and/or other types of systems.

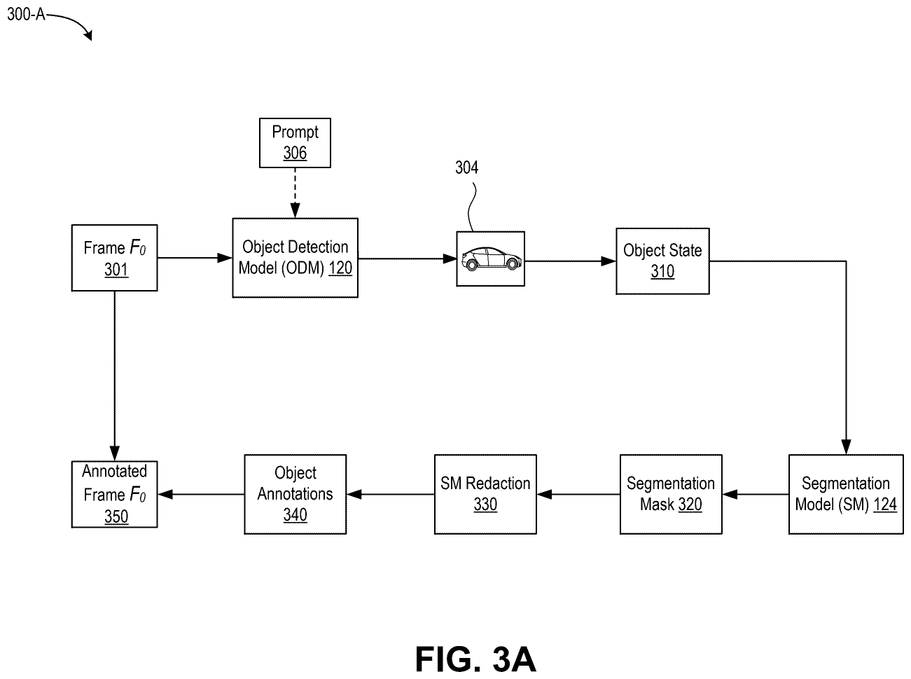

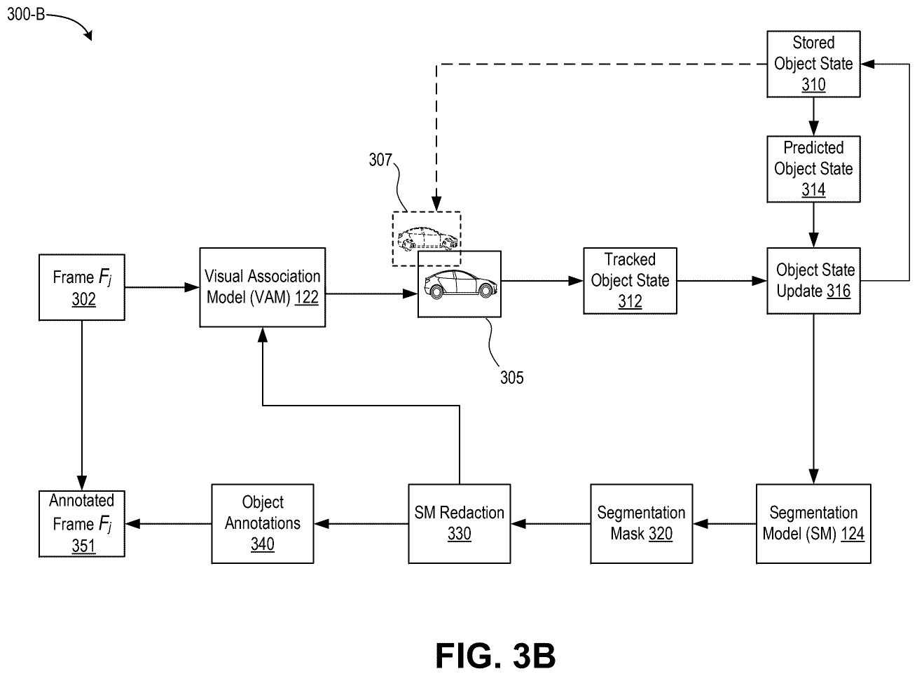

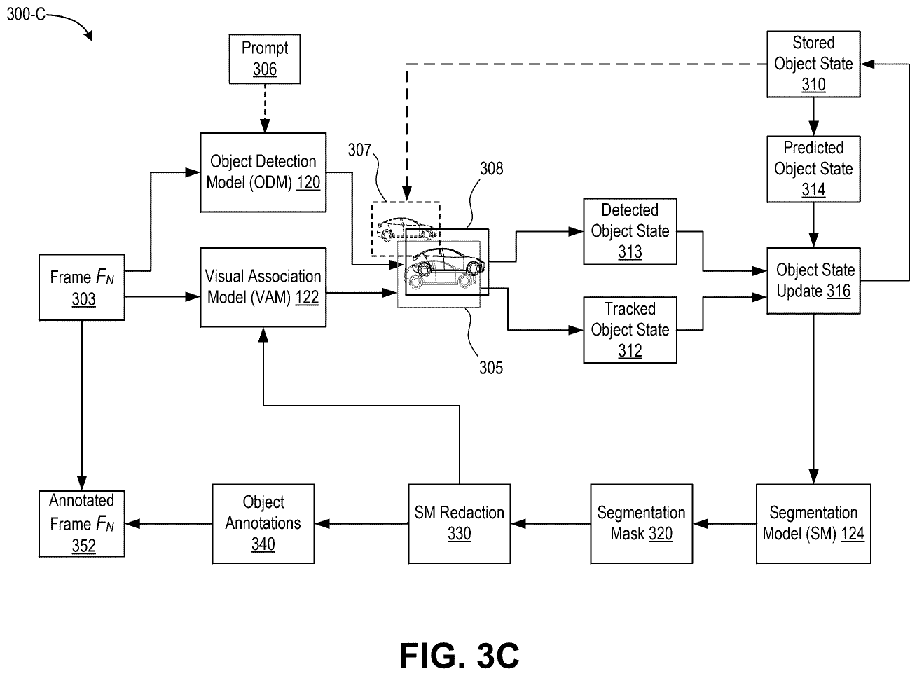

FIGS. 3A-3C illustrate an example data flow of segmentation-assisted detection and tracking of objects in videos, according to at least one embodiment. FIGS. 3A-3C depict operations of object detection stage 230 and segmentation stage 240 in FIG. 1, as may be performed in some embodiments. Operations illustrated in FIGS. 3A-3C may be performed for a set of frames F₀, F₁, F₂, . . . , of any suitable video (e.g., video 103 in FIG. 1). In some embodiments, different frames may undergo different types of processing. For example, a sparse set of reference frames F₀, F_{N}, F_{2N}, . . . , may be processed by a more computationally-heavy ODM 120 (or both ODM 120 and VAM 122) whereas non-reference frames F₁, . . . F_{N-1}, F_{N+1}, . . . . F_{2N-1}, F_{2N+1}, . . . , may be processed by a less computationally-heavy lightweight VAM 122. The spacing between reference frames is determined by number N that can be any integer number greater than one, e.g., N=2, 3, 4, 10, and/or the like.

FIG. 3A illustrates example processing 300-A of an initial reference frame 301 using segmentation-based tracking, according to at least one embodiment. The initial reference frame 301, e.g., F₀, may be processed by a trained ODM 120 that identifies locations of various objects in frame 301. In some embodiments, an additional input into ODM 120 may include a prompt 306, e.g., a prompt specifying target objects of interest to be identified in frame 301 (and other frames of the video). In some embodiments, prompt 306 may be a natural language prompt tokenized using a suitable numerical representation of words, phrases, etc., via tokens that can be understood by ODM 120.

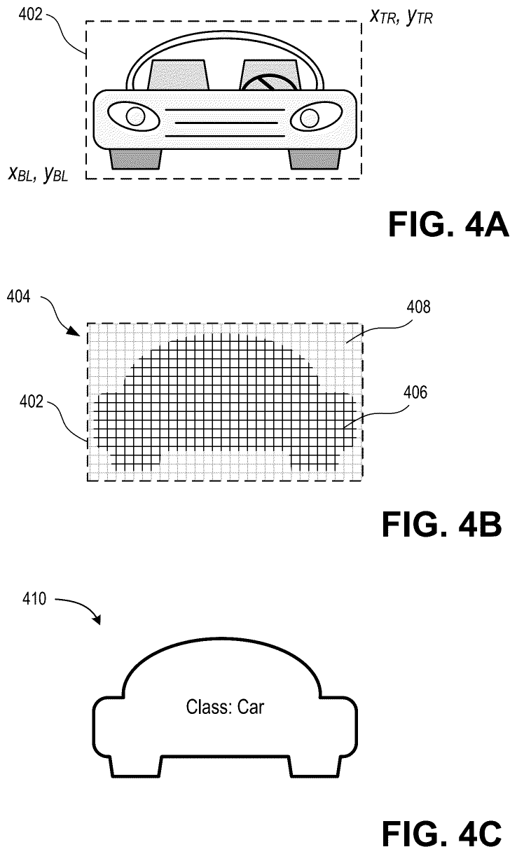

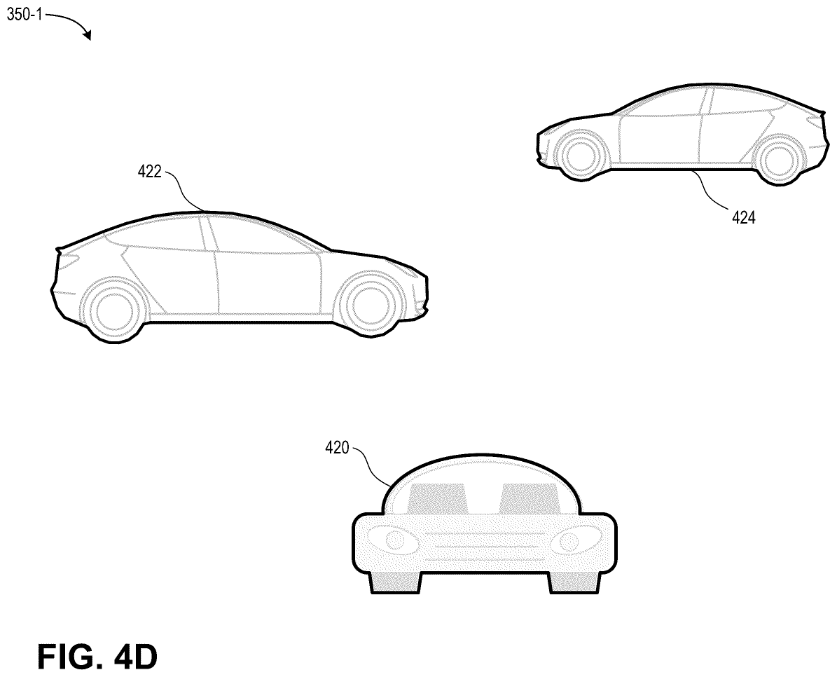

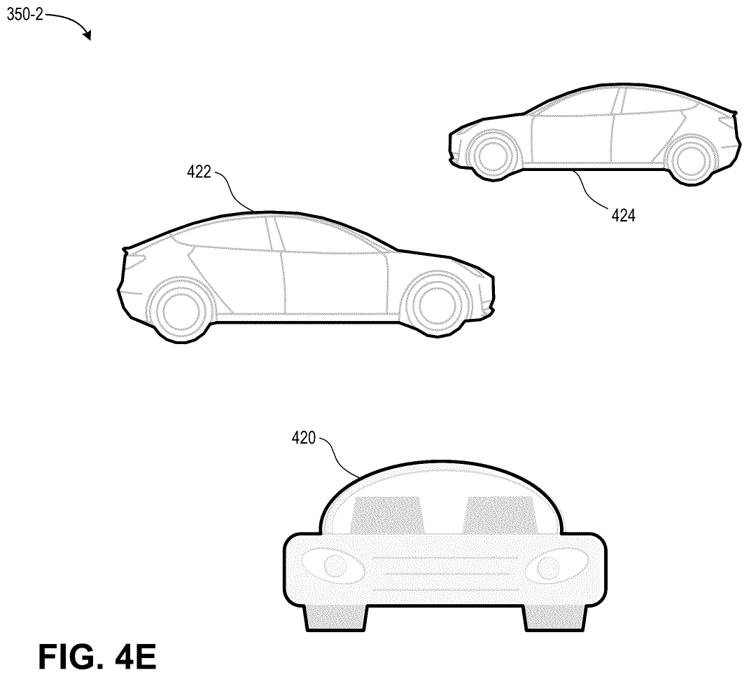

ODM 120 can output representations 304 of objects identified in frame 301. Representations 304 may include unique object identifiers (IDs) and locations of the objects. In some embodiments, locations of the objects may include bounding boxes BB₀, e.g., rectangles that encompass regions of the frame 301 depicting individual objects, polygons (convex hulls), and/or some other shapes. FIG. 4A illustrates a bounding box 402 for a car identified by an object detection model 120 of FIG. 3A, according to at least one embodiment. The bounding boxes and/or convex hulls may be identified by specifying coordinates of two or more vertices (corners) of the bounding boxes/convex hulls, e.g., coordinates x_{BL}, y_{BL} of the bottom left corner and coordinates x_{TR}, y_{TR} the top right (TR) corner of a bounding box BB₀. Representations 304 may further include object types, e.g., cars, trucks, pedestrians, animals, etc. Representations 304 may be used to initialize object states 310 that track motion and/or other evolution of the detected objects. For example, the initialized object state S₀ for a given object may include the object's bounding box BB₀. Additionally, object states may include velocities of the bounding boxes, e.g., the rate of motion of one or more vertices of the bounding boxes. A state of an object may track not only the coordinates of the object (e.g., x_{BL}, y_{BL}, x_{TR}, y_{TR}), but also the rates (e.g., \dot{x}_{BL}, \dot{y}_{BL}, \dot{x}_{TR}, \dot{y}_{TR}) at which the respective coordinates change with time (or frame number used as a proxy for time):

S=(x_{BL},y_{BL},x_{TR},y_{TR};\dot{x}_{BL},\dot{y}_{BL},\dot{x}_{TR},\dot{y}_{TR}).

(To fully initialize such a state, two or more frames may be used, to determine the speed and direction of the object's travel.) The state S predicts not only the direction of the object's travel but also the rates at which the object's dimensions are changing with time, e.g., \dot{L}ₓ=\dot{x}_{TR}−\dot{x}_{BL}, for the horizontal dimension and \dot{L}_{y}=\dot{y}_{TR}−\dot{y}_{BL}, for the vertical dimension.

The representation 304 may be processed by segmentation model (SM) 124 that generates pixel-level segmentation masks 320, e.g., classifications C(x, y) of various pixels x, y captured by the respective bounding boxes. In one example, classifications can be binary, e.g., with C=1 classification given to pixels that belong to the depiction of an object enclosed by the bounding box, and C=0 classification given to pixels that belong to the background or to other objects (or parts of objects) captured by the bounding boxes. FIG. 4B illustrates a segmentation mask 404 generated based on bounding box 402 of the car of FIG. 4A using a SM 124 of FIG. 3A, according to at least one embodiment. Darker pixels 406 in the segmentation mask are classified as belonging to the object (e.g., C=1) while lighter pixels 408 are classified as belonging to the background (e.g., C=0).

Referring again to FIG. 3A, in some embodiments, segmentation masks 320 may undergo segmentation mask redaction 330. More specifically, pixels classified as not belonging to the objects may be replaced with pixels of some predetermined intensity. For example, the predetermined intensity may be some neutral intensity that does not carry information, e.g., pixels with zero intensity, I=0, or one half of the maximum pixel intensity, I=Iₘₐₓ/2, or some other suitable intensity. Segmentation masks 320 with the background removed/redacted may be stored as reference for processing subsequent frames of the video. In some embodiments, segmentation masks 320 may be stored as part of objects' states 310. In some embodiments, segmentation masks 320 may include explicit identification of pixels associated with the objects, e.g., a boundary enclosing the area of an object. In other embodiments, segmentation masks 320 may be stored in the form of feature vectors (embeddings) encoding visual appearance of the masks.

In some embodiments, locations of the objects stored as part of object state 310 may include a center of mass (COM) of the respective segmentation masks, e.g., instead of bounding boxes or in addition to the bounding boxes. Storing and tracking COM may be more efficient in situations when COM is substantially different from the center of the bounding box, e.g., for L-shaped objects and/or the like, non-rigid objects that can change shape (e.g., basketball players), and so on.

In some embodiments, segmentation masks 320 may be used to generate object annotations 340 for various detected objects or features. Object or feature annotations may include boundaries or outlines of the objects in the frames and may further include object classifications. FIG. 4C illustrates an annotation 410 generated using segmentation mask 404 of FIG. 4B, according to at least one embodiment. Annotation 410 includes an outer boundary defined by the set of pixels of the segmentation mask classified as belonging to the object. Referring again to FIG. 3A, object annotations 340 may be added to frame 301 to obtain an annotated frame 350. Object annotations 340 may be embedded into frame 301, overlayed over frame 301, appended to frame 301, stored as metadata for frame 301, and/or associated with frame 301 in any other suitable way. FIGS. 4D-4E illustrate schematically a pair of frames 350-1 and 350-2 that depict multiple objects 420, 422, and 424 annotated with object outlines, according to at least one embodiment.

FIG. 3B illustrates example processing 300-B of non-reference frames using segmentation-based tracking, according to at least one embodiment. A non-reference frame 302 may be one of the frames, e.g., frames F₁, . . . . F_{N-1}, not scheduled for processing by ODM 120. Instead, frame 302 may be used as an input into VAM 122 that may be a lightweight (compared with ODM 120) model, requiring fewer processing operations and/or less memory to process a frame. VAM 122 may use, as another input, a segmentation mask 320 identified for one or more previous frames, which may include a reference frame (e.g., frame 301 of FIG. 3A) or another non-reference frame. In some embodiments, segmentation mask 320 used as an input into VAM 122 may be in the form of a feature vector. VAM 122 may be trained to identify a region in frame 302 having maximum visual similarity (correlation) to the object captured by segmentation mask for frame Fⱼ₋₁. As depicted schematically in FIG. 3B, a segmentation mask used as an input into VAM 122 may be a mask with the background removed, e.g., as disclosed in more detail in conjunction with FIG. 3A.

In some embodiments, VAM 122 may include a discriminative correlation filter (DCF) classifier that searches for a target region in frame 302 that has a maximum correlation with the segmentation mask input. The maximum correlation response may correspond to an estimated location of an object depicted in the segmentation mask input. In some embodiments, the DCF classifier may begin the search for the new location of the object in frame Fⱼ starting from the object's location in Fⱼ₋₁ and gradually expanding the search area. In some embodiments, the DCF classifier may include a Kernelized Correlation Filter (KCF), a discriminative Correlation Filter (DCF), a Correlation Filter Neural Network (CFNN), a Multi-Channel Correlation Filter (MCCF), a Kernel Correlation Filter, an adaptive correlation filter, and/or the like. In some embodiments, the DCF classifier may be implemented using one or more machine learning models. The machine learning models may include linear regression classifiers, logistic regression classifiers, decision tree classifiers, support vector machine (SVM) classifiers, Naïve Bayes classifiers, k-nearest neighbor classifiers, K-means clustering classifiers, random forest classifiers, dimensionality reduction classifiers, gradient boosting classifiers, neural networks (e.g., auto-encoders, convolutional, recurrent, perceptrons, long/short term memory/LSTM, Hopfield, Boltzmann, deep belief, deconvolutional, generative adversarial, liquid state machine, etc.), and/or other types of machine learning models.

An output of VAM 122 may include a representation 305 of an object in frame 302, e.g., a bounding box BBⱼ. In some embodiments, the representation 305 may be used directly as an input into SM 124. In some embodiments, a tracking filter, e.g., a Kalman filter, may be used for improved accuracy of object detection and tracking. Representation 305 may be used to determine a tracked object state 312, which may include bounding box BBⱼ, a new rate of change of the bounding box BBⱼ, and/or the like, which may be determined in relation to representation 307, which may be a part of stored object state 310 and may include the bounding box determined for a previous frame, e.g., Fⱼ₋₁. The stored object state 310 may also be used to determine a predicted object state 314. For example, the bounding box and the rate of change of the bounding box stored in association with frame Fⱼ₋₁ as part of the stored object state 310 may be extrapolated to frame Fⱼ. The tracked object state 312 and the predicted object state 314 may be used as inputs into the tracking filter that performs object state update 316. In some embodiments, object state update 316 may include computing a weighted combination of the tracked object state 312 (treated as a measurement by the tracking filter) and the predicted object state 314 with weights determined using a covariance value computed by the tracking filter based on estimated accuracy of previous tracked and predicted object states.

The updated object state may replace the stored object state 310 (for use with subsequent frames) and may also be used as an input into SM 124 to determine a new segmentation mask 320, e.g., substantially as described above in conjunction with FIG. 3A. Similarly, segmentation mask 320 may undergo segmentation mask redaction 330 and used as an input into VAM 122 during processing of the next frame Fⱼ₊₁. Segmentation masks 320 may be used to generate object annotations 340, which may be added to frame 302 to obtain an annotated frame 351.

FIG. 3C illustrates example processing 300-C of reference frames using multiple models as part of segmentation-based tracking, according to at least one embodiment. Reference frame 303 may be one of the frames, e.g., F_{N}, F_{2N}, F_{3N} . . . , scheduled for processing by ODM 120. Frame 303 may be used as an input into at least ODM 120 (e.g., as disclosed in conjunction with FIG. 3A), but may also be processed, in some embodiments, by VAM 122 (e.g., as disclosed in conjunction with FIG. 3B). ODM 120 may output a representation 308 (e.g., bounding box BBN, convex hull, and/or the like) that is used as detected object state 313, which may also include a new detected rate of change of the bounding box BBN. Additionally, in some embodiments, VAM 122 may independently output representation 305 that is used as tracked object state 312 (e.g., as disclosed in conjunction with FIG. 3B). In such embodiments, both the detected object state 313 and the tracked object state 312 may be used as inputs into the tracking filter that performs object state update 316. In various embodiments, relative weights given to the detected object state 313 and the tracked object state 312 may be set empirically. For example, in some embodiments, the detected object state 313 may be given a higher weight than the tracked object state 312. In some embodiments, detected object state 313 is presumed to be more accurate than the tracked object state 312. In such embodiments, processing by VAM 122 may not be performed and tracked object state 312 may not be generated. The updated object state may replace the stored object state 310 (for use with subsequent frames) and may be also used as an input into SM 124 to determine a new segmentation mask 320 and object annotations 340 added to frame 303 to obtain an annotated frame 352, e.g., substantially as described above in conjunction with FIG. 3A.

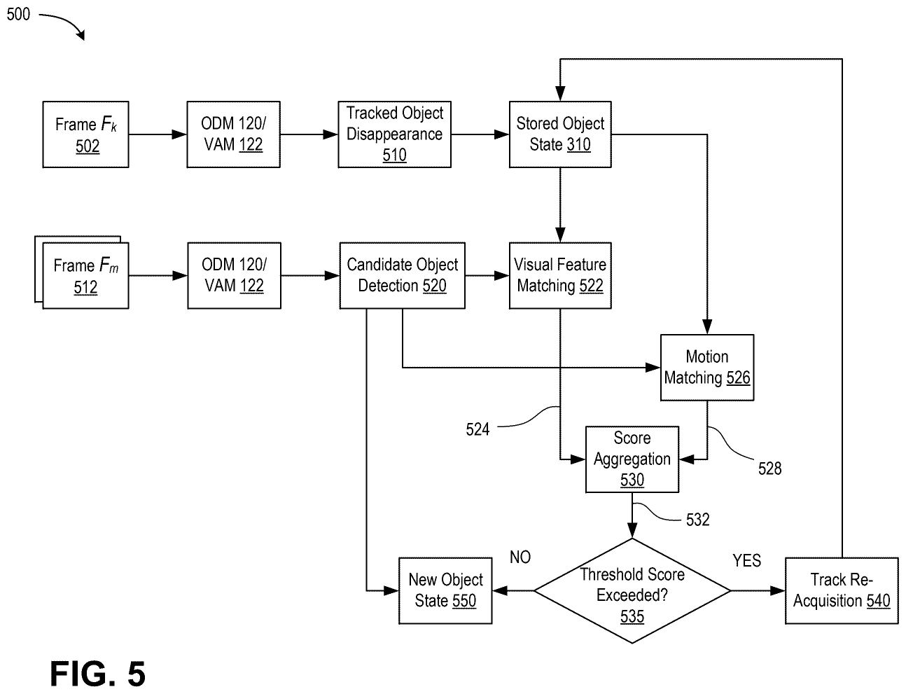

FIG. 5 illustrates example operations 500 of occluded object identification module 128 that identifies and maintains tracks of temporarily occluded objects as part of segmentation-assisted detection and tracking of objects in videos, according to at least one embodiment. Operations 500 may be used in the instances where previously tracked objects cannot be detected in one or more subsequent frames. For example, tracked objects may be occluded or partially occluded by other objects to a degree that a visible portion of the object(s) has a similarity to the previously stored visual features of the same objects that falls below a threshold similarity set for positive associations.

In some embodiments, processing of one or more frames Fₖ 502 by ODM 120 and/or VAM 122 and SM 124 may result in a tracked object disappearance 510 determination, e.g., a finding that one or more objects have been occluded by other objects, that one or more objects are no longer visually distinguishable from other objects, that one or more objects have left the field of view, and/or the like. In such instances, stored object state 310 for a disappeared object may be maintained until the object reappears or until the object fails to reappear after a maximum predetermined number of frames. Stored object state 310 may include the most recent bounding box for the object, the rate of change of the bounding box (which may include the velocity of the center of the bounding box and rates of change of the bounding box's dimension, etc.), and/or feature vectors (embeddings) corresponding to one or more segmentation mask for the disappeared object. In some embodiments, the stored object state 310 may include such information for multiple historical frames, e.g., M latest frames, of the video.

In some embodiments, when one or more subsequent frames Fₘ 512 (m>l) are received and processed by ODM 120, VAM 122, and/or SM 124, a candidate object detection 520 may occur, e.g., detection of an object that does not continuously track from preceding frames. Such candidate objects may be treated as potentially reappearing objects but also as potentially new objects. A representation (e.g., a bounding box) of the candidate object (e.g., generated by ODM 120 and/or VAM 122) and the object's appearance features (e.g., generated by SM 124) may undergo comparison to one or more stored object states 310. More specifically, visual feature matching 522 may be performed to generate a visual matching score 524 that characterizes visual similarity of the visual feature (feature vector) of the candidate object with stored visual features of disappeared objects. A high visual matching score 524 may indicate a high likelihood that the candidate object is a reappeared previously tracked object and a low visual matching score 524 may indicate a low likelihood of such an occurrence. In some embodiments, visual matching scores 524 may be (or include) cosine similarity scores, which may be obtained by computing a dot product of a visual feature of a disappeared object and a visual feature of the candidate object.

Additionally, motion matching 526 may be performed to generate a motion matching score 528 that extrapolates motion of the disappeared object(s) between frames Fₖ and Fₘ and compares the extrapolated locations and shapes (e.g., bounding boxes, convex hulls, boundaries/outlines, etc.) of the disappeared object(s) to the location and shape of the candidate object. For example, motion matching 526 may predict motion of the disappeared object(s) between frames Fₖ and Fₘ by maintaining velocity and/or other rates of change (e.g., of dimensions, aspect ratio, etc.) most recently (e.g., for frame Fₖ) associated with the disappeared object(s) and compare the resulting object representation(s) with similar representations of the candidate object (e.g., for frame Fₘ). In one non-limiting example, to obtain the motion matching score 528, an intersection-over-union (IoU) may be computed between the extrapolated bounding box of the disappeared object and the bounding box of the candidate object.

Visual matching score 524 and motion matching score 528 may be undergo score aggregation 530 to determine an aggregated score 532. For example, aggregated score 532 may be a weighted combination of the visual matching score 524 and the motion matching score 528 with empirically set weights assigned to individual matching scores.

In those instances where, at decision-making block 535, it is determined that the aggregated matching score 528 is above (or at) a certain (empirical) threshold score, the new object may be determined to be the same as the disappeared object and assigned the same ID. In such instances, track re-acquisition 540 may update stored object state with the most recent representation and/or visual features of the object and continue tracking the object, e.g., frame by frame, for as long as the object remains in the field of view.

In those instances where, at decision-making block 535, it is determined that the aggregated matching score 528 is below (or at, in some embodiments) the threshold score, the candidate object may be treated as a new object and a new object state 550 may be initialized, e.g., with the representation and/or visual features of the object associated with a new ID. The new object may then be tracked similarly to other objects.

The table below illustrates performance of various video processing pipelines deployed on a single A100 NVIDIA® GPU. The first row indicates performance (in processed frames per second) of a conventional pipeline with Grounding DINO ODM 120 used for processing each frame while outputting bounding boxes for detected object but no segmentation masks. The second row indicates performance of a conventional pipeline with ODM 120 used for processing each frame and generating segmentation mask. The additional computations of segmentation mask generation causes the frame rate to decrease form 7.93 fps to 6.00 fps. The third row indicates performance of the disclosed pipeline with both ODM 120 and VAM 122 deployed, with ODM 120 processing every second frame (inference interval N=2) and VAM 122 used to keep track of the objects in the skipped frames. The fourth row indicates performance of the disclosed pipeline where ODM 120 processes every third frame (inference interval N=3) and VAM 122 processing two skipped frames per each frame processed by ODM 120.

| System architecture | Frame rate | |
|---|---|---|
| ODM 120 | 7.93 | fps |
| ODM 120 + Segmentation Masks | 6.00 | fps |
| ODM 120 (N = 2) + VAM 122 + Segmentation Masks | 7.62 | fps |
| ODM 120 (N = 3) + VAM 122 + Segmentation Masks | 15.20 | fps |

As indicated by the last two lines, deployment of VAM 122 significantly improves the speed, nearly doubling it for N=3, while maintaining high accuracy. Additional increases in the speed of processing may be achieved with further increases of the inference interval N.

In some embodiments, inference rate N may be determined in view of available processing power (e.g., GPU clock speed) and frame rate. For example, if a pipeline that deploys ODM 120 and does not deploy a VAM (inference interval N=1), delivers 10 fps performance on a certain set of GPU(s), but the target frame rate is 30 fps, a pipeline with both ODM 120 and VAM 122 may be used with inference interval N=4. Alternatively, additional processing resources may be deployed (e.g., a faster GPU, or one or more additional GPUs), a different ODM 120 used, and/or both.

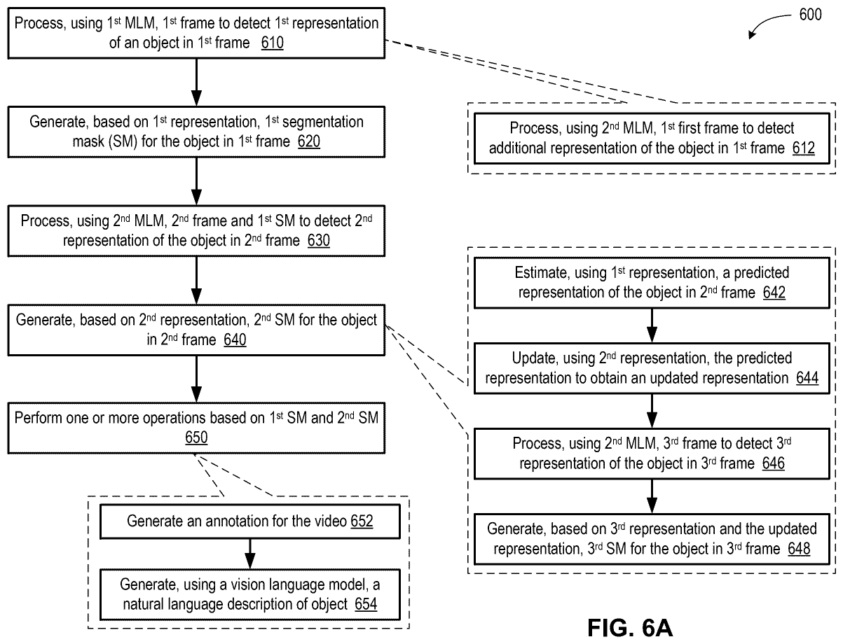

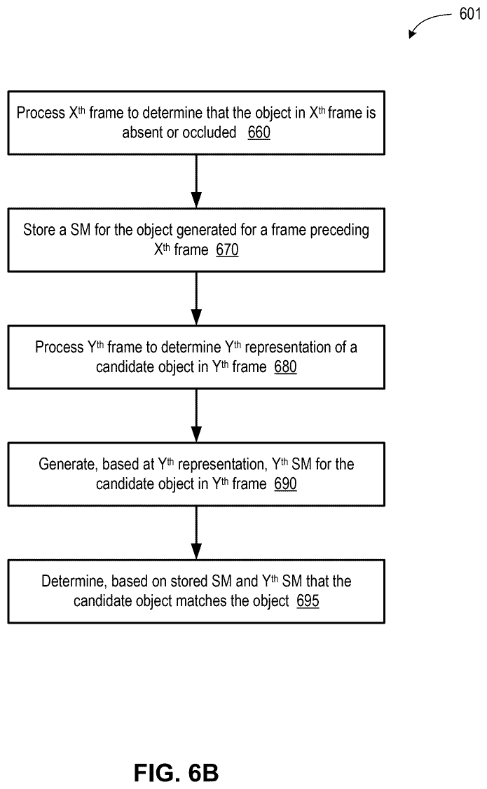

FIGS. 6A-6B depict flow diagrams of an example method 600 of segmentation-assisted detection and tracking of objects in videos, according to at least one embodiment. In at least one embodiment, method 600 may be performed using processing units of computing device 200 of FIG. 2, which may be (or include) SADT device 110, and/or other devices. In at least one embodiment, the processing units performing method 600 may be executing instructions stored on a non-transient computer-readable storage media. In at least one embodiment, method 600 may be performed using multiple processing threads (e.g., CPU threads and/or GPU threads), with individual threads executing one or more individual functions, routines, subroutines, or operations of the methods. In at least one embodiment, processing threads implementing method 600 may be synchronized (e.g., using semaphores, critical sections, and/or other thread synchronization mechanisms). Alternatively, processing threads implementing method 600 may be executed asynchronously with respect to each other. Various operations of method 600 may be performed in a different order compared with the order shown in FIGS. 6A-6B. Some operations of method 600 may be performed concurrently with other operations. In at least one embodiment, one or more operations shown in FIGS. 6A-6B may not always be performed.

Method 600 may be deployed to process a video and detect, annotate various objects in the video, and/or perform various additional operations associated with the video, e.g., use the processed/annotated video to perform one or more operations. Such operations may include vehicle control operations, manufacturing control operations, warehouse control operations, public safety control operations, and/or any other operations. Although, for brevity and conciseness, operations of method 600 are described below with reference to “an object,” substantially similar operations may be performed to detect and annotate any number of objects in a video. In some embodiments, method 600 may include processing a plurality of frames of a video to obtain a plurality of representations of an object depicted in the video. A first subset of the plurality of representations may be obtained by processing, using an object detection model, a first subset of the plurality of frames (e.g., frames F₀, F_{N}, F_{2N}, . . . ). A second subset of the plurality of representations may be obtained using visual similarity of an appearance of the object in a second subset of the plurality of frames (e.g., frames F₁, F₂, . . . . F_{N-1}, F_{N+1}, . . . ) to the appearance of the object in at least one (other) frame of the plurality of frames. Method 600 may further include generating, using a vision language model (VLM) and the plurality of representations, a natural language description of at least one of the object, a motion of the object, a type of action associated with the object, e.g., involving the object, performed on or by the object, and/or the like.

In some embodiments, the first subset of the plurality of frames (also referred to as the first plurality of frames herein) may be processed using a first MLM, e.g., ODM 120 in FIG. 3A and FIG. 3C, but may also be processed using a second MLM, e.g., visual association model (VAM) 122. The second subset of the plurality of frames (also referred to as the second plurality of frames herein) may be processed using the second MLM and not processed by the first MLM. In some embodiments, N consecutive frames of the video may include a frame of the first plurality of frames (e.g., frame F₀) and further include N−1 frames of the second plurality of frames (e.g., frames F₁, F₂, . . . . F_{N-1}), where inference interval N may be any integer number greater than one, e.g., two, three, four, and so on. In some embodiments, inference interval N may be set in view of a frame rate of the video, an amount of processing power available for execution of the first MLM, and/or the like. In some embodiments, method 600 may be executed on a single graphics processing unit (GPU) with a frame rate of the video being at least 15 frames per second.

In some embodiments, at block 610, method 600 may include processing, using a first MLM, a first frame of a video (e.g., one or frames F₀, F_{N}, F_{2N}, . . . ) to detect a first representation of an object in the first frame. In some embodiments, the first representation may include a bounding box for the object in the first frame, a convex hull for the object in the first frame, and/or the like. In some embodiments, as indicated with the top callout block 612 in FIG. 6, processing the first frame may include using the second MLM (e.g., VAM 122 in FIG. 3C) to detect a third representation of the object in the first frame. The first segmentation mask may then be further based on the third representation (e.g., as disclosed in conjunction with FIG. 3C).

At block 620, method 600 may continue with generating, based at least on the first representation, a first segmentation mask for the object in the first frame. For example, generating the first segmentation mask may include applying a third MLM (e.g., SM 124) to a portion of the first frame (e.g., a portion inside the bounding box) associated with the first representation to identify at least a subset of pixels of the portion of the first frame corresponding to the object (e.g., as illustrated with FIGS. 4A-4B). In some embodiments, generating the first segmentation mask includes redacting at least a portion of pixels of the first frame not associated with the object.

At block 630, method 600 may include processing, using the second MLM (e.g., VAM 122), a second frame (e.g., one or frames F₁, F_{N+1}, F_{2N+1}, . . . ) of the video and the first segmentation mask to detect a second representation of the object in the second frame.

At block 640, method 600 may continue with generating, based at least on the second representation, a second segmentation mask for the object in the second frame. In some embodiments, generating the second segmentation mask may include operations of the middle callout portion of FIG. 6. More specifically, at block 642, method 600 may include estimating, using at least the first representation (e.g., stored as part of stored object state 310), a predicted representation (e.g., as part of predicted object state 314) of the object in the second frame. At block 644, method 600 may continue with updating, using the second representation, the predicted representation to obtain an updated representation (e.g., as part of object state update 316) of the object in the second frame. In some embodiments, updating the predicted representation may include applying a tracking filter (e.g., Kalman filter) to the predicted representation and the second representation. The updated representation may be used to generate the second segmentation mask for the object in the second frame.

The updated representation may also be used for processing of subsequent frames. For example, at block 646, method 600 may include processing, using the second MLM, a third frame of the video (e.g., one or frames F₂, F_{N+2}, F_{2N+2}, . . . ) to detect a third representation of the object in the third frame. At block 648, method 600 may include generating, based on the third representation and the updated representation, a third segmentation mask for the object in the third frame.

At block 650, method 600 may continue with performing one or more operations based on the first segmentation mask and the second (third, etc.) segmentation mask. In some embodiments, performing the one or more operations may include operations of the bottom callout portion of FIG. 6. More specifically, at block 652, method 600 may include generating, based on the first segmentation mask and the second (third, etc.) segmentation mask, an annotation for the video. In some embodiments, the annotation for the video may include visible boundaries of detected objects in various frames of the video (e.g., as illustrated with FIG. 4C). At block 654, method 600 may continue with generating, using a vision language model (VLM), a natural language description of the object, a motion of the object, a type of action performed by the object, and/or the like. In some embodiments, an input into the VLM may include the video, the annotation for the video, a natural language prompt associated with the video (e.g., one or more questions, queries, instructions, etc.), and/or the like.

FIG. 6B illustrates a part 601 of method 600 related to handling of temporarily occluded objects or objects that temporarily departed from the field of view. For example, at block 660, method 600 may include processing a third frame of the video (which may be any X^{th} frame of the video) to determine that the object in the third frame is absent or occluded. For example, a segmentation mask for the object obtained for a previous frame may indicate that none of the regions of the third frame depicts an object having a sufficient (e.g., at least a threshold) similarity to the object. At block 670, method 600 may include storing a segmentation mask generated (for the object) for a frame preceding the third frame.

At block 680, method 600 may continue with processing a fourth frame of the video (which may be any Y^{th} frame of the video that is subsequent to the X^{th} frame) to determine a fourth representation of a candidate object in the fourth frame. At block 690, method 600 may include generating, based at least on the fourth representation, a fourth segmentation mask for the candidate object in the fourth frame. At block 695, method 600 may continue with determining, based at least on the third segmentation mask and the fourth segmentation mask that the candidate object matches the object. Performing the one or more operations may then be further based at least on the third segmentation mask and the fourth segmentation mask. For example, the third segmentation mask and the fourth segmentation mask may be used to resume a track for the object, annotate the object in the fourth (and subsequent) frame(s), use the annotation to generate a description of the video, and/or the like.

### Inference and Training Logic

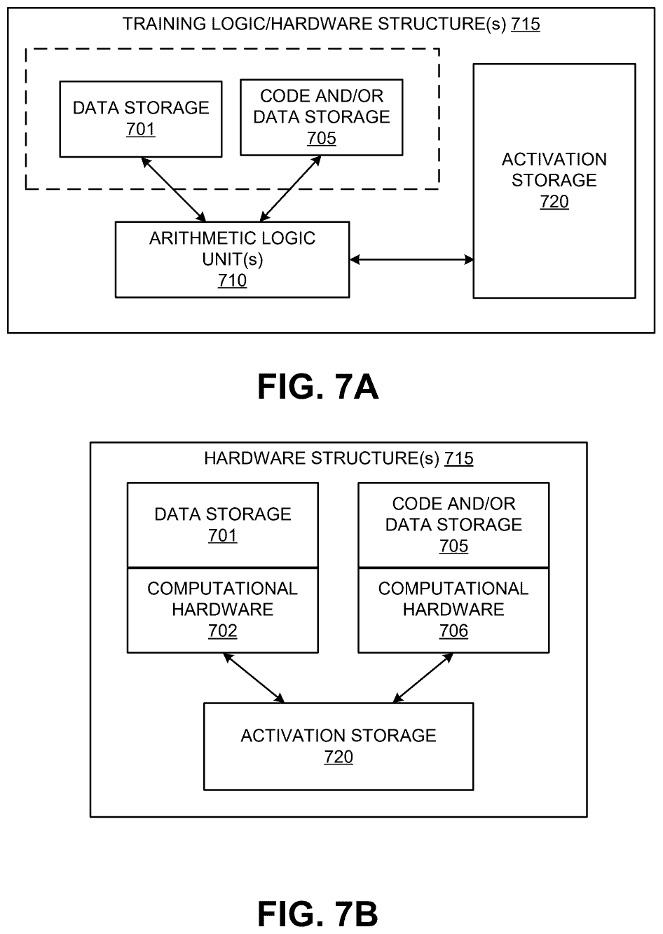

FIG. 7A illustrates inference and/or training logic 715 used to perform inferencing and/or training operations associated with one or more embodiments.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating-point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or code and/or data storage 701 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 701 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs).

In at least one embodiment, code, such as graph code, causes the loading of weight or other parameter information into processor ALUs based on an architecture of a neural network to which such code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to one or more processors or other hardware logic devices or circuits. In at least one embodiment, code and/or data storage 705 may be cache memory, DRAM, SRAM, non-volatile memory (e.g., flash memory), or other storage. In at least one embodiment, a choice of whether code and/or data storage 705 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be a combined storage structure. In at least one embodiment, code and/or data storage 701 and code and/or data storage 705 may be partially combined and partially separate. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALU(s) 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., flash memory), or other storage. In at least one embodiment, activation storage 720 may be completely or partially within or external to one or more processors or other logical circuits. In at least one embodiment, a choice of whether activation storage 720 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 illustrated in FIG. 7A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one storage/computational pair 701/702 of code and/or data storage 701 and computational hardware 702 is provided as an input to a next storage/computational pair 705/706 of code and/or data storage 705 and computational hardware 706, in order to mirror a conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage/computation pairs 701/702 and 705/706 may be included in inference and/or training logic 715.

### Neural Network Training and Deployment

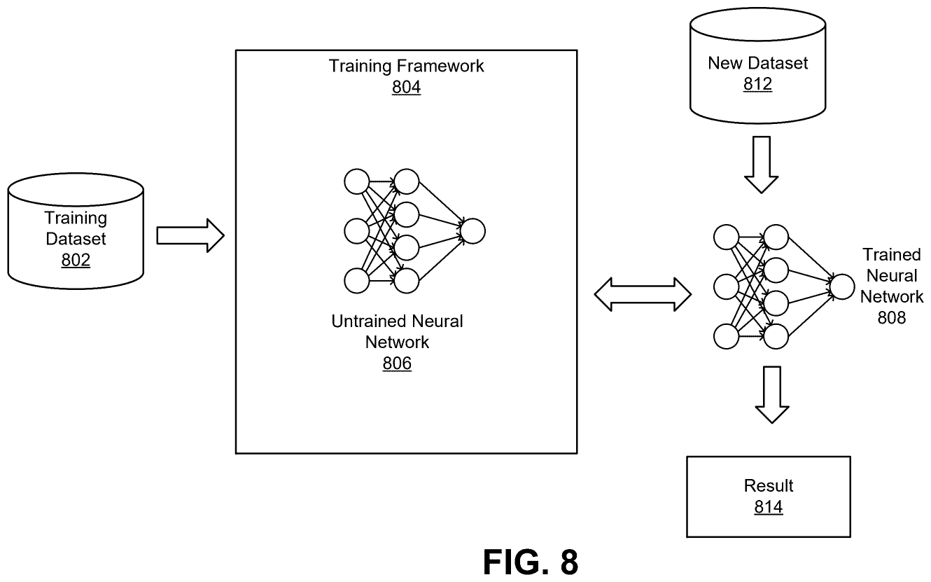

FIG. 8 illustrates training and deployment of a deep neural network, according to at least one embodiment. In at least one embodiment, untrained neural network 806 is trained using a training dataset 802. In at least one embodiment, training framework 804 is a PyTorch framework, whereas in other embodiments, training framework 804 is a TensorFlow, Boost, Caffe, Microsoft Cognitive Toolkit/CNTK, MXNet, Chainer, Keras, Deeplearning4j, or other training framework. In at least one embodiment, training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having a known output and an output of neural network 806 is manually graded. In at least one embodiment, untrained neural network 806 is trained in a supervised manner and processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on input data such as a new dataset 812. In at least one embodiment, training framework 804 trains untrained neural network 806 repeatedly while adjusting weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, whereas untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map in trained neural network 808 capable of performing operations useful in reducing dimensionality of new dataset 812. In at least one embodiment, unsupervised training can also be used to perform anomaly detection, which allows identification of data points in new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new dataset 812 without forgetting knowledge instilled within trained neural network 808 during initial training.

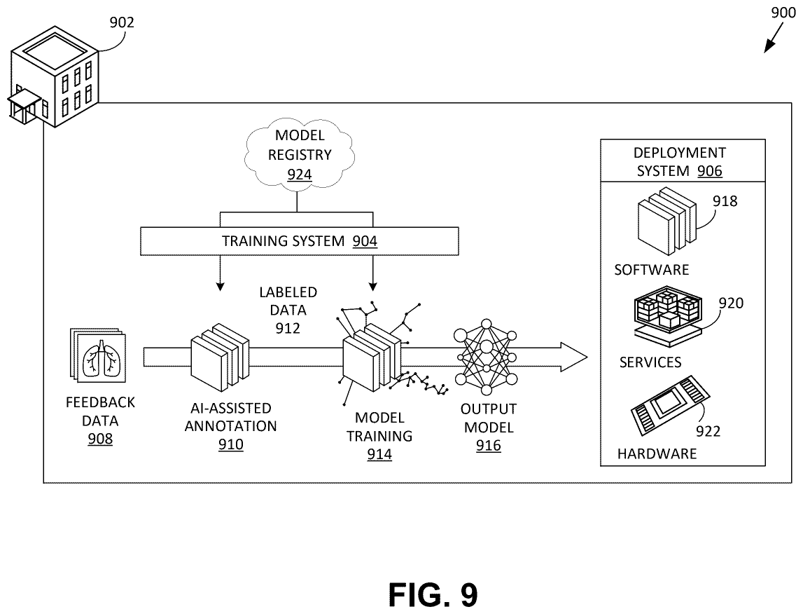

With reference to FIG. 9, FIG. 9 is an example data flow diagram for a process 900 of generating and deploying a processing and inferencing pipeline, according to at least one embodiment. In at least one embodiment, process 900 may be deployed to perform game name recognition analysis and inferencing on user feedback data at one or more facilities 902, such as a data center.

In at least one embodiment, process 900 may be executed within a training system 904 and/or a deployment system 906. In at least one embodiment, training system 904 may be used to perform training, deployment, and embodiment of machine learning models (e.g., neural networks, object detection algorithms, computer vision algorithms, etc.) for use in deployment system 906. In at least one embodiment, deployment system 906 may be configured to offload processing and compute resources among a distributed computing environment to reduce infrastructure requirements at facility 902. In at least one embodiment, deployment system 906 may provide a streamlined platform for selecting, customizing, and implementing virtual instruments for use with computing devices at facility 902. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 906 during execution of applications.

In at least one embodiment, some applications used in advanced processing and inferencing pipelines may use machine learning models or other AI to perform one or more processing steps. In at least one embodiment, machine learning models may be trained at facility 902 using feedback data 908 (such as imaging data) stored at facility 902 or feedback data 908 from another facility or facilities, or a combination thereof. In at least one embodiment, training system 904 may be used to provide applications, services, and/or other resources for generating working, deployable machine learning models for deployment system 906.

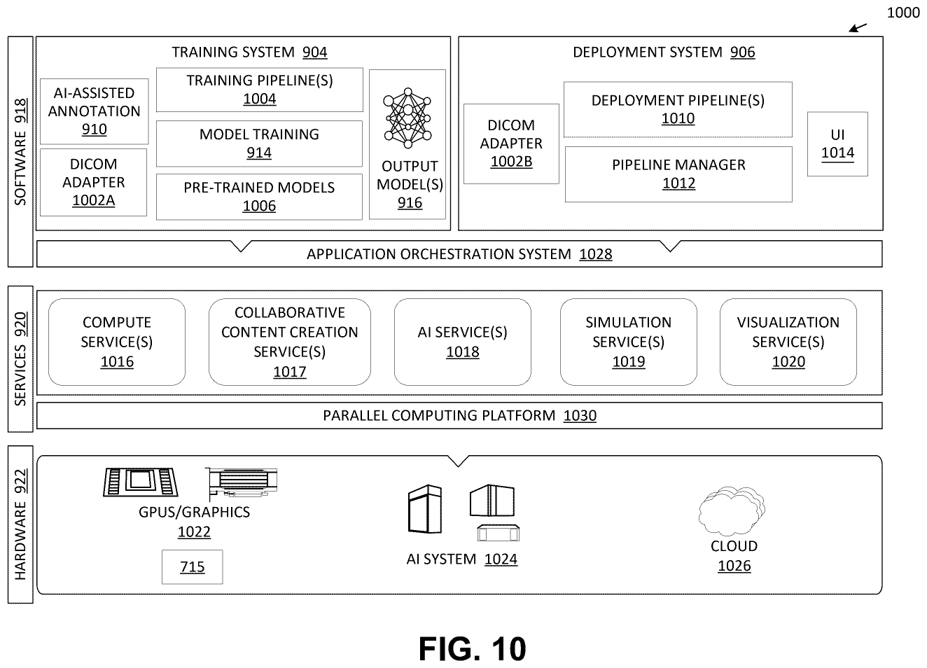

In at least one embodiment, a model registry 924 may be backed by object storage that may support versioning and object metadata. In at least one embodiment, object storage may be accessible through, for example, a cloud storage (e.g., a cloud 1026 of FIG. 10) compatible application programming interface (API) from within a cloud platform. In at least one embodiment, machine learning models within model registry 924 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline 1004 (FIG. 10) may include a scenario where facility 902 is training their own machine learning model, or has an existing machine learning model that needs to be optimized or updated. In at least one embodiment, feedback data 908 may be received from various channels, such as forums, web forms, or the like. In at least one embodiment, once feedback data 908 is received, AI-assisted annotation 910 may be used to aid in generating annotations corresponding to feedback data 908 to be used as ground truth data for a machine learning model. In at least one embodiment, AI-assisted annotation 910 may include one or more machine learning models (e.g., convolutional neural networks (CNNs)) that may be trained to generate annotations corresponding to certain types of feedback data 908 (e.g., from certain devices) and/or certain types of anomalies in feedback data 908. In at least one embodiment, AI-assisted annotations 910 may then be used directly, or may be adjusted or fine-tuned using an annotation tool, to generate ground truth data. In at least one embodiment, in some examples, labeled data 912 may be used as ground truth data for training a machine learning model. In at least one embodiment, AI-assisted annotations 910, labeled data 912, or a combination thereof may be used as ground truth data for training a machine learning model, e.g., via model training 914 in FIGS. 9-10. In at least one embodiment, a trained machine learning model may be referred to as an output model 916, and may be used by deployment system 906, as described herein.

In at least one embodiment, training pipeline 1004 (FIG. 10) may include a scenario where facility 902 needs a machine learning model for use in performing one or more processing tasks for one or more applications in deployment system 906, but facility 902 may not currently have such a machine learning model (or may not have a model that is optimized, efficient, or effective for such purposes). In at least one embodiment, an existing machine learning model may be selected from model registry 924. In at least one embodiment, model registry 924 may include machine learning models trained to perform a variety of different inference tasks on imaging data. In at least one embodiment, machine learning models in model registry 924 may have been trained on imaging data from different facilities than facility 902 (e.g., facilities that are remotely located). In at least one embodiment, machine learning models may have been trained on imaging data from one location, two locations, or any number of locations. In at least one embodiment, when being trained on imaging data, which may be a form of feedback data 908, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained—or partially trained—at one location, a machine learning model may be added to model registry 924. In at least one embodiment, a machine learning model may then be retrained, or updated, at any number of other facilities, and a retrained or updated model may be made available in model registry 924. In at least one embodiment, a machine learning model may then be selected from model registry 924—and referred to as output model 916—and may be used in deployment system 906 to perform one or more processing tasks for one or more applications of a deployment system.

In at least one embodiment, training pipeline 1004 (FIG. 10) may be used in a scenario that includes facility 902 requiring a machine learning model for use in performing one or more processing tasks for one or more applications in deployment system 906, but facility 902 may not currently have such a machine learning model (or may not have a model that is optimized, efficient, or effective for such purposes). In at least one embodiment, a machine learning model selected from model registry 924 might not be fine-tuned or optimized for feedback data 908 generated at facility 902 because of differences in populations, genetic variations, robustness of training data used to train a machine learning model, diversity in anomalies of training data, and/or other issues with training data. In at least one embodiment, AI-assisted annotation 910 may be used to aid in generating annotations corresponding to feedback data 908 to be used as ground truth data for retraining or updating a machine learning model. In at least one embodiment, labeled data 912 may be used as ground truth data for training a machine learning model. In at least one embodiment, retraining or updating a machine learning model may be referred to as model training 914. In at least one embodiment, model training 914—e.g., AI-assisted annotations 910, labeled data 912, or a combination thereof—may be used as ground truth data for retraining or updating a machine learning model.

In at least one embodiment, deployment system 906 may include software 918, services 920, hardware 922, and/or other components, features, and functionality. In at least one embodiment, deployment system 906 may include a software “stack,” such that software 918 may be built on top of services 920 and may use services 920 to perform some or all of processing tasks, and services 920 and software 918 may be built on top of hardware 922 and use hardware 922 to execute processing, storage, and/or other compute tasks of deployment system 906.

In at least one embodiment, software 918 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 908 (or other data types, such as those described herein). In at least one embodiment, an advanced processing and inferencing pipeline may be defined based on selections of different containers that are desired or required for processing feedback data 908, in addition to containers that receive and configure imaging data for use by each container and/or for use by facility 902 after processing through a pipeline (e.g., to convert outputs back to a usable data type for storage and display at facility 902). In at least one embodiment, a combination of containers within software 918 (e.g., that make up a pipeline) may be referred to as a virtual instrument (as described in more detail herein), and a virtual instrument may leverage services 920 and hardware 922 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 916 of training system 904.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 924 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 920 as a system (e.g., architecture 1000 of FIG. 10). In at least one embodiment, once validated by architecture 1000 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., architecture 1000 of FIG. 10). In at least one embodiment, completed and validated applications or containers may be stored in a container registry and associated machine learning models may be stored in model registry 924. In at least one embodiment, a requesting entity that provides an inference or image processing request may browse a container registry and/or model registry 924 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 906 (e.g., a cloud) to perform processing of a data processing pipeline. In at least one embodiment, processing by deployment system 906 may include referencing selected elements (e.g., applications, containers, models, etc.) from a container registry and/or model registry 924. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 920 may be leveraged. In at least one embodiment, services 920 may include compute services, collaborative content creation services, simulation services, artificial intelligence (AI) services, visualization services, and/or other service types. In at least one embodiment, services 920 may provide functionality that is common to one or more applications in software 918, so functionality may be abstracted to a service that may be called upon or leveraged by applications. In at least one embodiment, functionality provided by services 920 may run dynamically and more efficiently, while also scaling well by allowing applications to process data in parallel, e.g., using a parallel computing platform 1030 (FIG. 10). In at least one embodiment, rather than each application that shares a same functionality offered by a service 920 being required to have a respective instance of service 920, service 920 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 920 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 918 implementing advanced processing and inferencing pipeline may be streamlined because each application may call upon the same inference service to perform one or more inferencing tasks.

In at least one embodiment, hardware 922 may include GPUs, CPUs, graphics cards, an AI/deep learning system (e.g., an AI supercomputer, such as NVIDIA's DGX™ supercomputer system), a cloud platform, or a combination thereof. In at least one embodiment, different types of hardware 922 may be used to provide efficient, purpose-built support for software 918 and services 920 in deployment system 906. In at least one embodiment, use of GPU processing may be implemented for processing locally (e.g., at facility 902), within an AI/deep learning system, in a cloud system, and/or in other processing components of deployment system 906 to improve efficiency, accuracy, and efficacy of game name recognition.

In at least one embodiment, software 918 and/or services 920 may be optimized for GPU processing with respect to deep learning, machine learning, and/or high-performance computing, simulation, and visual computing, as non-limiting examples. In at least one embodiment, at least some of the computing environment of deployment system 906 and/or training system 904 may be executed in a datacenter or one or more supercomputers or high performance computing systems, with GPU-optimized software (e.g., hardware and software combination of NVIDIA's DGX™ system). In at least one embodiment, hardware 922 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 10 is a system diagram for an example architecture 1000 for generating and deploying a deployment pipeline, according to at least one embodiment. In at least one embodiment, architecture 1000 may be used to implement process 900 of FIG. 9 and/or other processes including advanced processing and inferencing pipelines. In at least one embodiment, architecture 1000 may include training system 904 and deployment system 906. In at least one embodiment, training system 904 and deployment system 906 may be implemented using software 918, services 920, and/or hardware 922, as described herein.

In at least one embodiment, architecture 1000 (e.g., training system 904 and/or deployment system 906) may implemented in a cloud computing environment (e.g., using cloud 1026). In at least one embodiment, architecture 1000 may be implemented locally with respect to a facility, or as a combination of both cloud and local computing resources. In at least one embodiment, access to APIs in cloud 1026 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of architecture 1000, may be restricted to a set of public internet service providers (ISPs) that have been vetted or authorized for interaction.

In at least one embodiment, various components of architecture 1000 may communicate between and among one another using any of a variety of different network types, including but not limited to local area networks (LANs) and/or wide area networks (WANs) via wired and/or wireless communication protocols. In at least one embodiment, communication between facilities and components of architecture 1000 (e.g., for transmitting inference requests, for receiving results of inference requests, etc.) may be communicated over a data bus or data busses, wireless data protocols (Wi-Fi), wired data protocols (e.g., Ethernet), etc.

In at least one embodiment, training system 904 may execute training pipelines 1004, similar to those described herein with respect to FIG. 9. In at least one embodiment, where one or more machine learning models are to be used in deployment pipelines 1010 by deployment system 906, training pipelines 1004 may be used to train or retrain one or more (e.g., pre-trained) models, and/or implement one or more of pre-trained models 1006 (e.g., without a need for retraining or updating). In at least one embodiment, as a result of training pipelines 1004, output model(s) 916 may be generated. In at least one embodiment, training pipelines 1004 may include any number of processing steps, AI-assisted annotation 910, labeling or annotating of feedback data 908 to generate labeled data 912, model selection from a model registry, model training 914, training, retraining, or updating models, and/or other processing steps. In at least one embodiment, for different machine learning models used by deployment system 906, different training pipelines 1004 may be used. In at least one embodiment, training pipeline 1004, similar to a first example described with respect to FIG. 9, may be used for a first machine learning model, training pipeline 1004, similar to a second example described with respect to FIG. 9, may be used for a second machine learning model, and training pipeline 1004, similar to a third example described with respect to FIG. 9, may be used for a third machine learning model. In at least one embodiment, any combination of tasks within training system 904 may be used depending on what is required for each respective machine learning model. In at least one embodiment, one or more of machine learning models may already be trained and ready for deployment so machine learning models may not undergo any processing by training system 904, and may be implemented by deployment system 906.

In at least one embodiment, output model(s) 916 and/or pre-trained model(s) 1006 may include any types of machine learning models depending on embodiment. In at least one embodiment, and without limitation, machine learning models used by architecture 1000 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipelines 1004 may include AI-assisted annotation. In at least one embodiment, labeled data 912 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 908 (or other data type used by machine learning models), there may be corresponding ground truth data generated by training system 904. In at least one embodiment, AI-assisted annotation may be performed as part of deployment pipelines 1010; either in addition to, or in lieu of, AI-assisted annotation included in training pipelines 1004. In at least one embodiment, architecture 1000 may include a multi-layer platform that may include a software layer (e.g., software 918) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 902. In at least one embodiment, applications may then call or execute one or more services 920 for performing compute, AI, or visualization tasks associated with respective applications, and software 918 and/or services 920 may leverage hardware 922 to perform processing tasks in an effective and efficient manner.

In at least one embodiment, deployment system 906 may execute deployment pipelines 1010. In at least one embodiment, deployment pipelines 1010 may include any number of applications that may be sequentially, non-sequentially, or otherwise applied to feedback data (and/or other data types), including AI-assisted annotation, as described above. In at least one embodiment, as described herein, a deployment pipeline 1010 for an individual device may be referred to as a virtual instrument for a device. In at least one embodiment, for a single device, there may be more than one deployment pipeline 1010 depending on information desired from data generated by a device.

In at least one embodiment, applications available for deployment pipelines 1010 may include any application that may be used for performing processing tasks on feedback data or other data from devices. In at least one embodiment, because various applications may share common image operations, in some embodiments, a data augmentation library (e.g., as one of services 920) may be used to accelerate these operations. In at least one embodiment, to avoid bottlenecks of conventional processing approaches that rely on CPU processing, parallel computing platform 1030 may be used for GPU acceleration of these processing tasks.

In at least one embodiment, deployment system 906 may include a user interface (UI) 1014 (e.g., a graphical user interface, a web interface, etc.) that may be used to select applications for inclusion in deployment pipeline(s) 1010, arrange applications, modify or change applications or parameters or constructs thereof, use and intera with deployment pipeline(s) 1010 during set-up and/or deployment, and/or to otherwise interact with deployment system 906. In at least one embodiment, although not illustrated with respect to training system 904, UI 1014 (or a different user interface) may be used for selecting models for use in deployment system 906, for selecting models for training, or retraining, in training system 904, and/or for otherwise interacting with training system 904. In at least one embodiment, training system 904 and deployment system 906 may include DICOM adapters 1002A and 1002B.

In at least one embodiment, pipeline manager 1012 may be used, in addition to an application orchestration system 1028, to manage interaction between applications or containers of deployment pipeline(s) 1010 and services 920 and/or hardware 922. In at least one embodiment, pipeline manager 1012 may be configured to facilitate interactions from application to application, from application to service 920, and/or from application or service to hardware 922. In at least one embodiment, although illustrated as included in software 918, this is not intended to be limiting, and in some examples pipeline manager 1012 may be included in services 920. In at least one embodiment, application orchestration system 1028 (e.g., Kubernetes, DOCKER, etc.) may include a container orchestration system that may group applications into containers as logical units for coordination, management, scaling, and deployment. In at least one embodiment, by associating applications from deployment pipeline(s) 1010 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 1012 and application orchestration system 1028. In at least one embodiment, so long as an expected input and/or output of each container or application is known by a system (e.g., based on constructs of applications or containers), application orchestration system 1028 and/or pipeline manager 1012 may facilitate communication among and between, and sharing of resources among and between, each of applications or containers. In at least one embodiment, because one or more of applications or containers in deployment pipeline(s) 1010 may share the same services and resources, application orchestration system 1028 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 1028) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 920 leveraged and shared by applications or containers in deployment system 906 may include compute services 1016, collaborative content creation services 1017, AI services 1018, simulation services 1019, visualization services 1020, and/or other service types. In at least one embodiment, applications may call (e.g., execute) one or more of services 920 to perform processing operations for an application. In at least one embodiment, compute services 1016 may be leveraged by applications to perform super-computing or other high-performance computing (HPC) tasks. In at least one embodiment, compute service(s) 1016 may be leveraged to perform parallel processing (e.g., using a parallel computing platform 1030) for processing data through one or more of applications and/or one or more tasks of a single application, substantially simultaneously. In at least one embodiment, parallel computing platform 1030 (e.g., NVIDIA's CUDA®) may enable general purpose computing on GPUs (GPGPU) (e.g., GPUs 1022). In at least one embodiment, a software layer of parallel computing platform 1030 may provide access to virtual instruction sets and parallel computational elements of GPUs, for execution of compute kernels. In at least one embodiment, parallel computing platform 1030 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1030 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1018 may be leveraged to perform inferencing services for executing machine learning model(s) associated with applications (e.g., tasked with performing one or more processing tasks of an application). In at least one embodiment, AI services 1018 may leverage AI system 1024 to execute machine learning model(s) (e.g., neural networks, such as CNNs) for segmentation, reconstruction, object detection, feature detection, classification, and/or other inferencing tasks. In at least one embodiment, applications of deployment pipeline(s) 1010 may use one or more of output models 916 from training system 904 and/or other models of applications to perform inference on imaging data (e.g., DICOM data, RIS data, CIS data, REST compliant data, RPC data, raw data, etc.). In at least one embodiment, two or more examples of inferencing using application orchestration system 1028 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1028 may distribute resources (e.g., services 920 and/or hardware 922) based on priority paths for different inferencing tasks of AI services 1018.

In at least one embodiment, shared storage may be mounted to AI services 1018 within architecture 1000. In at least one embodiment, shared storage may operate as a cache (or other storage device type) and may be used to process inference requests from applications. In at least one embodiment, when an inference request is submitted, a request may be received by a set of API instances of deployment system 906, and one or more instances may be selected (e.g., for best fit, for load balancing, etc.) to process a request. In at least one embodiment, to process a request, a request may be entered into a database, a machine learning model may be located from model registry 924 if not already in a cache, a validation step may ensure appropriate machine learning model is loaded into a cache (e.g., shared storage), and/or a copy of a model may be saved to a cache. In at least one embodiment, the scheduler (e.g., of pipeline manager 1012) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between services 920 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1026, and an inference service may perform inferencing on a GPU.

In at least one embodiment, visualization services 1020 may be leveraged to generate visualizations for viewing outputs of applications and/or deployment pipeline(s) 1010. In at least one embodiment, GPUs 1022 may be leveraged by visualization services 1020 to generate visualizations. In at least one embodiment, rendering effects, such as ray-tracing or other light transport simulation techniques, may be implemented by visualization services 1020 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 1020 may include an internal visualizer, cinematics, and/or other rendering or image processing capabilities or functionality (e.g., ray tracing, rasterization, internal optics, etc.).

In at least one embodiment, hardware 922 may include GPUs 1022, AI system 1024, cloud 1026, and/or any other hardware used for executing training system 904 and/or deployment system 906. In at least one embodiment, GPUs 1022 (e.g., NVIDIA's TESLA® and/or QUADRO® GPUs) may include any number of GPUs that may be used for executing processing tasks of compute services 1016, collaborative content creation services 1017, AI services 1018, simulation services 1019, visualization services 1020, other services, and/or any of features or functionality of software 918. For example, with respect to AI services 1018, GPUs 1022 may be used to perform pre-processing on imaging data (or other data types used by machine learning models), post-processing on outputs of machine learning models, and/or to perform inferencing (e.g., to execute machine learning models). In at least one embodiment, cloud 1026, AI system 1024, and/or other components of architecture 1000 may use GPUs 1022. In at least one embodiment, cloud 1026 may include a GPU-optimized platform for deep learning tasks. In at least one embodiment, AI system 1024 may use GPUs, and cloud 1026—or at least a portion tasked with deep learning or inferencing—may be executed using one or more AI systems 1024. As such, although hardware 922 is illustrated as discrete components, this is not intended to be limiting, and any components of hardware 922 may be combined with, or leveraged by, any other components of hardware 922.

In at least one embodiment, AI system 1024 may include a purpose-built computing system (e.g., a super-computer or an HPC) configured for inferencing, deep learning, machine learning, and/or other artificial intelligence tasks. In at least one embodiment, AI system 1024 (e.g., NVIDIA's DGX™) may include GPU-optimized software (e.g., a software stack) that may be executed using a plurality of GPUs 1022, in addition to CPUs, RAM, storage, and/or other components, features, or functionality. In at least one embodiment, one or more AI systems 1024 may be implemented in cloud 1026 (e.g., in a data center) for performing some or all of AI-based processing tasks of architecture 1000.

In at least one embodiment, cloud 1026 may include a GPU-accelerated infrastructure (e.g., NVIDIA's NGC™) that may provide a GPU-optimized platform for executing processing tasks of architecture 1000. In at least one embodiment, cloud 1026 may include an AI system(s) 1024 for performing one or more of AI-based tasks of architecture 1000 (e.g., as a hardware abstraction and scaling platform). In at least one embodiment, cloud 1026 may integrate with application orchestration system 1028 leveraging multiple GPUs to enable seamless scaling and load balancing between and among applications and services 920. In at least one embodiment, cloud 1026 may be tasked with executing at least some of services 920 of architecture 1000, including compute services 1016, AI services 1018, and/or visualization services 1020, as described herein. In at least one embodiment, cloud 1026 may perform small and large batch inference (e.g., executing NVIDIA's TensorRT™), provide an accelerated parallel computing API and platform 1030 (e.g., NVIDIA's CUDA®), execute application orchestration system 1028 (e.g., KUBERNETES), provide a graphics rendering API and platform (e.g., for ray-tracing, 2D graphics, 3D graphics, and/or other rendering techniques to produce higher quality cinematics), and/or may provide other functionality for architecture 1000.

In at least one embodiment, in an effort to preserve patient confidentiality (e.g., where patient data or records are to be used off-premises), cloud 1026 may include a registry, such as a deep learning container registry. In at least one embodiment, a registry may store containers for instantiations of applications that may perform pre-processing, post-processing, or other processing tasks on patient data. In at least one embodiment, cloud 1026 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

### Example Language Models

In at least some embodiments, language models, such as large language models (LLMs) and/or other types of generative artificial intelligence (AI) may be implemented. These models may be capable of understanding, summarizing, translating, and/or otherwise generating text (e.g., natural language text, code, etc.), images, video, computer aided design (CAD) assets, omniverse and/or metaverse file information (e.g., in USD format), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/etc. may be implemented for summarizing textual data, analyzing and extracting insights from data (e.g., textual, image, video, etc.), and generating new text/image/video/etc. in user-specified styles, tones, or formats. The LLMs of the present disclosure may be used exclusively for text processing, in embodiments, whereas in other embodiments, multimodal LLMs may be implemented to accept, understand, and/or generate text along with other types of content like images, audio, and/or video. For example, vision language models (VLMs), or more generally multimodal language models, may be implemented to accept image, video, audio, textual, 3D design (e.g., CAD), and/or other inputs data types and/or to generate or output image, video, audio, textual, 3D design, and/or other output data types.

Various types of LLM/VLM/etc. architectures may be implemented in various embodiments. For example, different architectures may be implemented that use different techniques for understanding and generating outputs-such as text, audio, video, image, etc. In some embodiments, LLM architectures such as recurrent neural networks (RNNs) or long short-term memory networks (LSTMs) may be used, while in other embodiments transformer architectures—such as those that rely on self-attention mechanisms—may be used to understand and recognize relationships between words or tokens. The language models of the present disclosure may include encoder and/or decoder block(s). For example, discriminative or encoder-only LLMs like BERT (Bidirectional Encoder Representations from Transformers) may be implemented for tasks that involve language comprehension such as classification, sentiment analysis, question answering, and named entity recognition. As another example, generative or decoder-only LLMs like GPT (Generative Pretrained Transformer) may be implemented for tasks that involve language and content generation such as text completion, story generation, and dialogue generation. LLMs that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the model(s).

In various embodiments, the LLMs/VLMs/etc. may be trained using unsupervised learning, in which an LLM learns patterns from large amounts of unlabeled text/audio/video/image/etc. data. Due to the extensive training, in embodiments, the models may not require task-specific or domain-specific training. LLMs that have undergone extensive pre-training on vast amounts of unlabeled text data may be referred to as foundation models and may be adept at a variety of tasks like question-answering, summarization, filling in missing information, and translation. Some LLMs may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/etc. of the present disclosure may be implemented using various model alignment techniques. For example, in some embodiments, guardrails may be implemented to identify improper or undesired inputs (e.g., prompts) and/or outputs of the models. In some non-limiting embodiments, the guardrails implemented may be similar to those described in U.S. Pat. App. No. 18,304,341, filed on Apr. 20, 2023, the contents of which are hereby incorporated by reference in their entirety. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/embodiment. As a result, the LLMs/VLMs/etc. of the present disclosure may be less likely to output language/text/audio/etc. that may be offensive, vulgar, improper, unsafe, out of domain, and/or otherwise undesired for the particular application/embodiment.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3rd party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources-such as APIs, plug-ins, and/or the like.

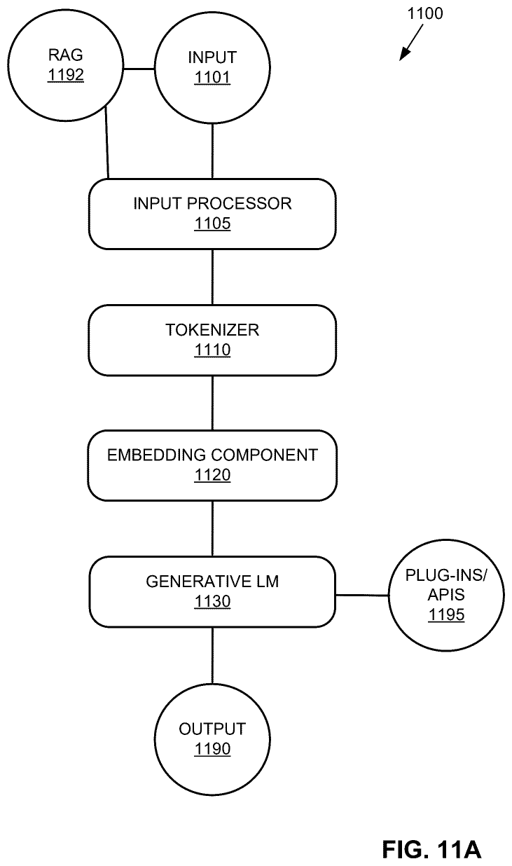

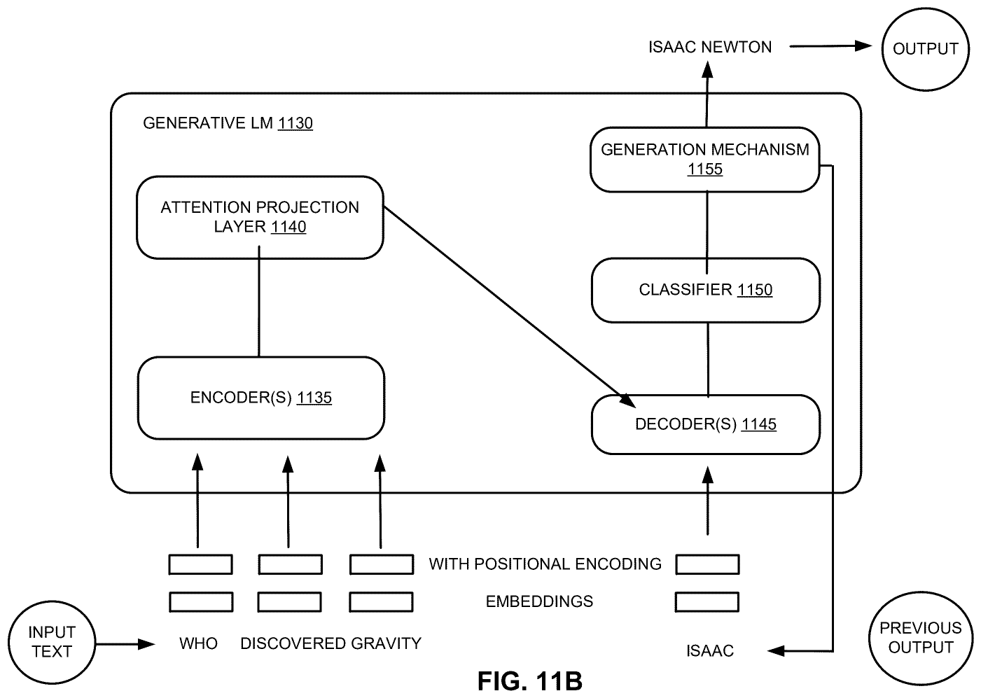

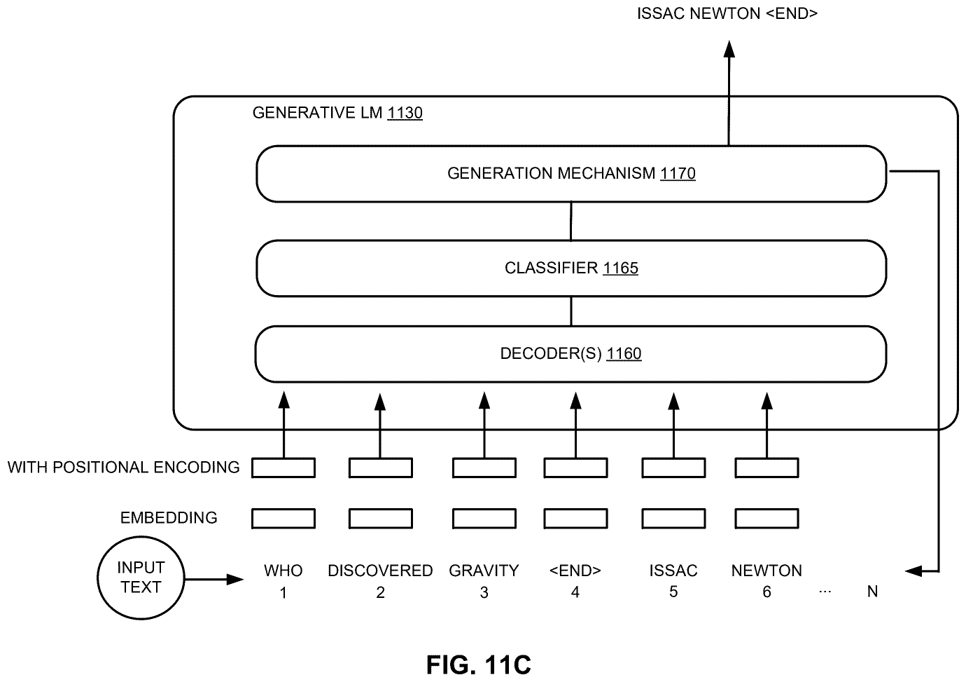

FIG. 11A is a block diagram of an example generative language model system 1100 suitable for use in implementing at least some embodiments of the present disclosure. In the example illustrated in FIG. 11A, the generative language model system 1100 includes a retrieval augmented generation (RAG) component 1192, an input processor 1105, a tokenizer 1110, an embedding component 1120, plug-ins/APIs 1195, and a generative language model (LM) 1130 (which may include an LLM, a VLM, a multi-modal LM, etc.).

At a high level, the input processor 1105 may receive an input 1101 comprising text and/or other types of input data (e.g., audio data, video data, image data, sensor data (e.g., LiDAR, RADAR, ultrasonic, etc.), 3D design data, CAD data, universal scene descriptor (USD) data, etc.), depending on the architecture of the generative LM 1130. In some embodiments, the input 1101 includes plain text in the form of one or more sentences, paragraphs, and/or documents. Additionally or alternatively, the input 1101 may include numerical sequences, precomputed embeddings (e.g., word or sentence embeddings), and/or structured data (e.g., in tabular formats, JSON, or XML). In some embodiments in which the generative LM 1130 is capable of processing multimodal inputs, the input 1101 may combine text with image data, audio data, and/or other types of input data, such as but not limited to those described herein. Taking raw input text as an example, the input processor 1105 may prepare raw input text in various ways. For example, the input processor 1105 may perform various types of text cleaning to remove noise (e.g., special characters, punctuation, HTML tags, stopwords) from relevant textual content. In an example involving stopwords (common words that tend to carry little semantic meaning), the input processor 1105 may remove stopwords to reduce noise and focus the generative LM 1130 on more meaningful content. The input processor 1105 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1192 may be used to retrieve additional information to be used as part of the input 1101 or prompt. For example, in some embodiments, the input 1101 may be generated using the query or input to the model (e.g., a question, a request, etc.) in addition to data retrieved using the RAG component 1192. In some embodiments, the input processor 1105 may analyze the input 1101 and communicate with the RAG component 1192 (or the RAG component 1192 may be part of the input processor 1105, in embodiments) in order to identify relevant text and/or other data to provide to the generative LM 1130 as additional context or sources of information from which to identify the response, answer, or output 1190, generally. For example, where the input indicates that the user is interested in a desired tire pressure for a particular make and model of vehicle, the RAG component 1192 may retrieve—using a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1192 may retrieve a prior stored conversation history—or at least a summary thereof—and include the prior conversation history along with the current ask/request as part of the input 1101 to the generative LM 1130.

The tokenizer 1110 may segment the (e.g., processed) text into smaller units (tokens) for subsequent analysis and processing. The tokens may represent individual words, subwords, characters, etc., depending on the embodiment. Word-based tokenization divides the text into individual words, treating each word as a separate token. Subword tokenization breaks down words into smaller meaningful units (e.g., prefixes, suffixes, stems), enabling the generative LM 1130 to understand morphological variations and handle out-of-vocabulary words more effectively. Character-based tokenization represents each character as a separate token, enabling the generative LM 1130 to process text at a fine-grained level. The choice of tokenization strategy may depend on factors such as the language being processed, the task at hand, and/or characteristics of the training dataset. As such, the tokenizer 1110 may convert the (e.g., processed) text into a structured format according to tokenization schema being implemented in the particular embodiment.

The embedding component 1120 may use any known embedding technique to transform discrete tokens into (e.g., dense, continuous vector) representations of semantic meaning. For example, the embedding component 1120 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some embodiments in which the input 1101 includes image data, the input processor 1101 may resize the image data to a standard size compatible with format of a corresponding input channel and/or may normalize pixel values to a common range (e.g., 0 to 1) to ensure a consistent representation, and the embedding component 1120 may encode the image data using any known technique (e.g., using one or more convolutional neural networks (CNNs) to extract visual features). In some embodiments in which the input 1101 includes audio data, the input processor 1101 may resample an audio file to a consistent sampling rate for uniform processing, and the embedding component 1120 may use any known technique to extract and encode audio features-such as in the form of a spectrogram (e.g., a mel-spectrogram). In some embodiments in which the input 1101 includes video data, the input processor 1101 may extract frames or apply resizing to extracted frames, and the embedding component 1120 may extract features such as optical flow embeddings or video embeddings and/or may encode temporal information or sequences of frames. In some embodiments in which the input 1101 includes multimodal data, the embedding component 1120 may fuse representations of the different types of data (e.g., text, image, audio) using techniques like early fusion (concatenation), late fusion (sequential processing), attention-based fusion, etc.

The generative LM 1130 and/or other components of the generative LLM system 1100 may use different types of neural network architectures depending on the embodiment. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multimodal), RNNs, LSTMs, fusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the embodiment and architecture, the embedding component 1120 may apply an encoded representation of the input 1101 to the generative LM 1130, and the generative LM 1130 may process the encoded representation of the input 1101 to generate an output 1190, which may include responsive text and/or other types of data.

As described herein, in some embodiments, the generative LM 1130 may be configured to access or use—or capable of accessing or using—plug-ins/APIs 1195 (which may include one or more plug-ins, application programming interfaces (APIs), databases, data stores, repositories, etc.). For example, for certain tasks or operations that the generative LM 1130 is not ideally suited for, the model may have instructions (e.g., as a result of training, and/or based on instructions in a given prompt, such as those retrieved using the RAG component 1192) to access one or more plug-ins/APIs 1195 (e.g., 3rd party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1195 to the plug-in/API 1195, the plug-in/API 1195 may process the information and return an answer to the generative LM 1130, and the generative LM 1130 may use the response to generate the output 1190. This process may be repeated—e.g., recursively—for any number of iterations and using any number of plug-ins/APIs 1195 until an output 1190 that addresses each ask/question/request/process/operation/etc from the input 1101 can be generated. As such, the model(s) may not only rely on its own knowledge from training on a large dataset(s) and/or from data retrieved using the RAG component 1192, but also on the expertise or optimized nature of one or more external resources-such as the plug-ins/APIs 1195.

FIG. 11B is a block diagram of an example embodiment in which the generative LM 1130 includes a transformer encoder-decoder, according to at least one embodiment. For example, assume input text such as “Who discovered gravity” is tokenized (e.g., by the tokenizer 1110 of FIG. 11A) into tokens such as words, and each token is encoded (e.g., by the embedding component 1120 of FIG. 911A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1135 of the generative LM 1130.

In an example embodiment, the encoder(s) 1135 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1140 may convert the context vector into attention vectors (keys and values) for the decoder(s) 1145.

In an example embodiment, the decoder(s) 1145 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1135, in an example transformer architecture, each token (e.g., word) flows through a separate path in the decoder(s) 1145. During a first pass, the decoder(s) 1145, a classifier 1150, and a generation mechanism 1155 may generate a first token, and the generation mechanism 1155 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1145 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example embodiment, the encoder-decoder attention layer operates similarly to the (e.g., multi-headed) self-attention in the encoder(s) 1135, except that it creates its queries from the layer below it and takes the keys and values (e.g., matrix) from the output of the encoder(s) 1135.

As such, the decoder(s) 1145 may output some decoded (e.g., vector) representation of the input being applied during a particular pass. The classifier 1150 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1155 may select or sample a word or token based on a corresponding predicted probability (e.g., select the word with the highest predicted probability) and append it to the output from a previous pass, generating each word or token sequentially. The generation mechanism 1155 may repeat the process, triggering successive decoder inputs and corresponding predictions until selecting or sampling a symbol or token that represents the end of the response, at which point, the generation mechanism 1155 may output the generated response.

FIG. 11C is a block diagram of an example embodiment in which the generative LM 1130 includes a decoder-only transformer architecture, according to at least one embodiment. For example, the decoder(s) 1160 of FIG. 11C may operate similarly as the decoder(s) 1145 of FIG. 11B except each of the decoder(s) 1160 of FIG. 11C omits the encoder-decoder self-attention layer (since there is no encoder in this embodiment). As such, the decoder(s) 1160 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1160. As with the decoder(s) 1145 of FIG. 11B, each token (e.g., word) may flow through a separate path in the decoder(s) 1160, and the decoder(s) 1160, a classifier 1165, and a generation mechanism 1170 may use auto-regression to sequentially generate one token at a time until predicting a symbol or token that represents the end of the response. The classifier 1165 and the generation mechanism 1170 may operate similarly as the classifier 1150 and the generation mechanism 1155 of FIG. 11B, with the generation mechanism 1170 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

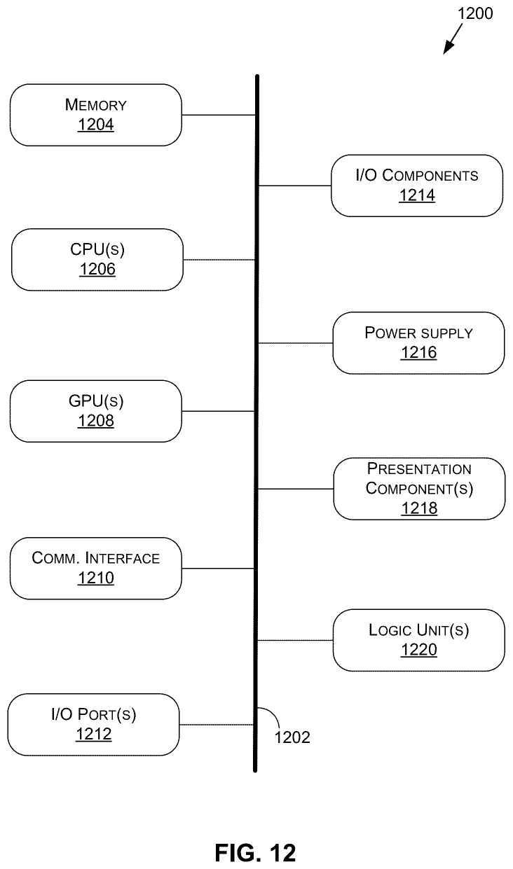

FIG. 12 is a block diagram of an example computing device(s) 1200 suitable for use in implementing some embodiments of the present disclosure. Computing device 1200 may include an interconnect system 1202 that directly or indirectly couples the following devices: memory 1204, one or more central processing units (CPUs) 1206, one or more graphics processing units (GPUs) 1208, a communication interface 1210, input/output (I/O) ports 1212, input/output components 1214, a power supply 1216, one or more presentation components 1218 (e.g., display(s)), and one or more logic units 1220. In at least one embodiment, the computing device(s) 1200 may comprise one or more virtual machines (VMs), and/or any of the components thereof may comprise virtual components (e.g., virtual hardware components). For non-limiting examples, one or more of the GPUs 1208 may comprise one or more vGPUs, one or more of the CPUs 1206 may comprise one or more vCPUs, and/or one or more of the logic units 1220 may comprise one or more virtual logic units. As such, a computing device(s) 1200 may include discrete components (e.g., a full GPU dedicated to the computing device 1200), virtual components (e.g., a portion of a GPU dedicated to the computing device 1200), or a combination thereof.

Although the various blocks of FIG. 12 are shown as connected via the interconnect system 1202 with lines, this is not intended to be limiting and is for clarity only. For example, in some embodiments, a presentation component 1218, such as a display device, may be considered an I/O component 1214 (e.g., if the display is a touch screen). As another example, the CPUs 1206 and/or GPUs 1208 may include memory (e.g., the memory 1204 may be representative of a storage device in addition to the memory of the GPUs 1208, the CPUs 1206, and/or other components). As such, the computing device of FIG. 12 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 12.

The interconnect system 1202 may represent one or more links or busses, such as an address bus, a data bus, a control bus, or a combination thereof. The interconnect system 1202 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1206 may be directly connected to the memory 1204. Further, the CPU 1206 may be directly connected to the GPU 1208. Where there is direct, or point-to-point connection between components, the interconnect system 1202 may include a PCIe link to carry out the connection. In these examples, a PCI bus need not be included in the computing device 1200.

The memory 1204 may include any of a variety of computer-readable media. The computer-readable media may be any available media that may be accessed by the computing device 1200. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1204 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1200. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1206 may be configured to execute at least some of the computer-readable instructions to control one or more components of the computing device 1200 to perform one or more of the methods and/or processes described herein. The CPU(s) 1206 may each include one or more cores (e.g., one, two, four, eight, twenty-eight, seventy-two, etc.) that are capable of handling a multitude of software threads simultaneously. The CPU(s) 1206 may include any type of processor, and may include different types of processors depending on the type of computing device 1200 implemented (e.g., processors with fewer cores for mobile devices and processors with more cores for servers). For example, depending on the type of computing device 1200, the processor may be an Advanced RISC Machines (ARM) processor implemented using Reduced Instruction Set Computing (RISC) or an x86 processor implemented using Complex Instruction Set Computing (CISC). The computing device 1200 may include one or more CPUs 1206 in addition to one or more microprocessors or supplementary co-processors, such as math co-processors.

In addition to or alternatively from the CPU(s) 1206, the GPU(s) 1208 may be configured to execute at least some of the computer-readable instructions to control one or more components of the computing device 1200 to perform one or more of the methods and/or processes described herein. One or more of the GPU(s) 1208 may be an integrated GPU (e.g., with one or more of the CPU(s) 1206 and/or one or more of the GPU(s) 1208 may be a discrete GPU. In embodiments, one or more of the GPU(s) 1208 may be a coprocessor of one or more of the CPU(s) 1206. The GPU(s) 1208 may be used by the computing device 1200 to render graphics (e.g., 3D graphics) or perform general purpose computations. For example, the GPU(s) 1208 may be used for General-Purpose computing on GPUs (GPGPU). The GPU(s) 1208 may include hundreds or thousands of cores that are capable of handling hundreds or thousands of software threads simultaneously. The GPU(s) 1208 may generate pixel data for output images in response to rendering commands (e.g., rendering commands from the CPU(s) 1206 received via a host interface). The GPU(s) 1208 may include graphics memory, such as display memory, for storing pixel data or any other suitable data, such as GPGPU data. The display memory may be included as part of the memory 1204. The GPU(s) 1208 may include two or more GPUs operating in parallel (e.g., via a link). The link may directly connect the GPUs (e.g., using NVLINK) or may connect the GPUs through a switch (e.g., using NVSwitch). When combined together, each GPU 1208 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1206 and/or the GPU(s) 1208, the logic unit(s) 1220 may be configured to execute at least some of the computer-readable instructions to control one or more components of the computing device 1200 to perform one or more of the methods and/or processes described herein. In embodiments, the CPU(s) 1206, the GPU(s) 1208, and/or the logic unit(s) 1220 may discretely or jointly perform any combination of the methods, processes and/or portions thereof. One or more of the logic units 1220 may be part of and/or integrated in one or more of the CPU(s) 1206 and/or the GPU(s) 1208 and/or one or more of the logic units 1220 may be discrete components or otherwise external to the CPU(s) 1206 and/or the GPU(s) 1208. In embodiments, one or more of the logic units 1220 may be a coprocessor of one or more of the CPU(s) 1206 and/or one or more of the GPU(s) 1208.

Examples of the logic unit(s) 1220 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs), one or more decoupled accelerators (e.g., decoupled lookup table (DLUT) accelerators), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1210 may include one or more receivers, transmitters, and/or transceivers that allow the computing device 1200 to communicate with other computing devices via an electronic communication network, included wired and/or wireless communications. The communication interface 1210 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1220 and/or communication interface 1210 may include one or more data processing units (DPUs) to transmit data received over a network and/or through interconnect system 1202 directly to (e.g., a memory of) one or more GPU(s) 1208.

The I/O ports 1212 may allow the computing device 1200 to be logically coupled to other devices including the I/O components 1214, the presentation component(s) 1218, and/or other components, some of which may be built in to (e.g., integrated in) the computing device 1200. Illustrative I/O components 1214 include a microphone, mouse, keyboard, joystick, game pad, game controller, satellite dish, scanner, printer, wireless device, etc. The I/O components 1214 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1200. The computing device 1200 may be include depth cameras, such as stereoscopic camera systems, infrared camera systems, RGB camera systems, touchscreen technology, and combinations of these, for gesture detection and recognition. Additionally, the computing device 1200 may include accelerometers or gyroscopes (e.g., as part of an inertia measurement unit (IMU)) that allow detection of motion. In some examples, the output of the accelerometers or gyroscopes may be used by the computing device 1200 to render immersive augmented reality or virtual reality.

The power supply 1216 may include a hard-wired power supply, a battery power supply, or a combination thereof. The power supply 1216 may provide power to the computing device 1200 to allow the components of the computing device 1200 to operate.

The presentation component(s) 1218 may include a display (e.g., a monitor, a touch screen, a television screen, a heads-up-display (HUD), other display types, or a combination thereof), speakers, and/or other presentation components. The presentation component(s) 1218 may receive data from other components (e.g., the GPU(s) 1208, the CPU(s) 1206, DPUs, etc.), and output the data (e.g., as an image, video, sound, etc.).

### Example Data Center

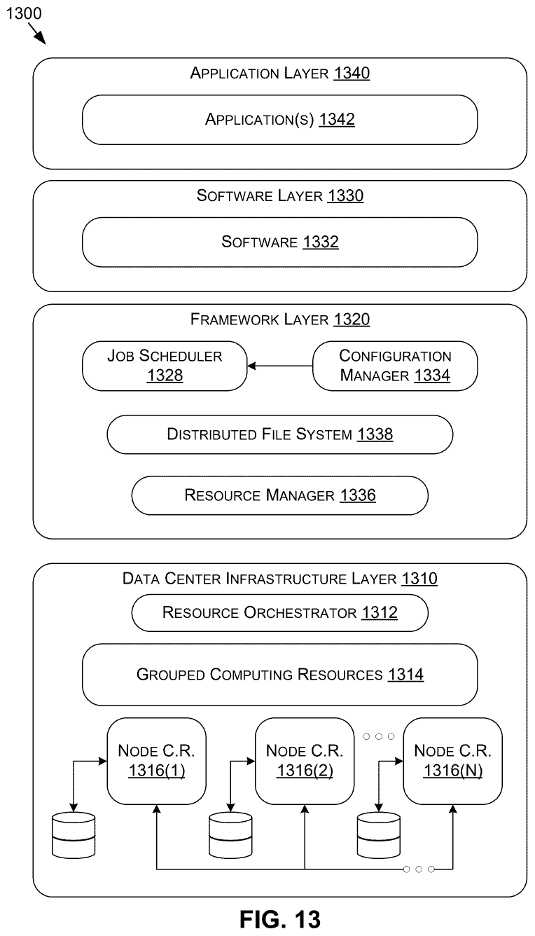

FIG. 13 illustrates an example data center 1300 that may be used in at least one embodiments of the present disclosure. The data center 1300 may include a data center infrastructure layer 1310, a framework layer 1320, a software layer 1330, and/or an application layer 1340.

As shown in FIG. 13, the data center infrastructure layer 1310 may include a resource orchestrator 1312, grouped computing resources 1314, and node computing resources (“node C.R.s”) 1316(1)-1316(N), where “N” represents any whole, positive integer. In at least one embodiment, node C.R.s 1316(1)-1316(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1316(1)-1316(N) may correspond to a server having one or more of the above-mentioned computing resources. In addition, in some embodiments, the node C.R.s 1316(1)-13161(N) may include one or more virtual components, such as vGPUs, vCPUs, and/or the like, and/or one or more of the node C.R.s 1316(1)-1316(N) may correspond to a virtual machine (VM).

In at least one embodiment, grouped computing resources 1314 may include separate groupings of node C.R.s 1316 housed within one or more racks (not shown), or many racks housed in data centers at various geographical locations (also not shown). Separate groupings of node C.R.s 1316 within grouped computing resources 1314 may include grouped compute, network, memory or storage resources that may be configured or allocated to support one or more workloads. In at least one embodiment, several node C.R.s 1316 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1312 may configure or otherwise control one or more node C.R.s 1316(1)-1316(N) and/or grouped computing resources 1314. In at least one embodiment, resource orchestrator 1312 may include a software design infrastructure (SDI) management entity for the data center 1300. The resource orchestrator 1312 may include hardware, software, or some combination thereof.

In at least one embodiment, as shown in FIG. 13, framework layer 1320 may include a job scheduler 1328, a configuration manager 1334, a resource manager 1336, and/or a distributed file system 1338. The framework layer 1320 may include a framework to support software 1332 of software layer 1330 and/or one or more application(s) 1342 of application layer 1340. The software 1332 or application(s) 1342 may respectively include web-based service software or applications, such as those provided by Amazon Web Services, Google Cloud and Microsoft Azure. The framework layer 1320 may be, but is not limited to, a type of free and open-source software web application framework such as Apache Spark™ (hereinafter “Spark”) that may use distributed file system 1338 for large-scale data processing (e.g., “big data”). In at least one embodiment, job scheduler 1328 may include a Spark driver to facilitate scheduling of workloads supported by various layers of data center 1300. The configuration manager 1334 may be capable of configuring different layers such as software layer 1330 and framework layer 1320 including Spark and distributed file system 1338 for supporting large-scale data processing. The resource manager 1336 may be capable of managing clustered or grouped computing resources mapped to or allocated for support of distributed file system 1338 and job scheduler 1328. In at least one embodiment, clustered or grouped computing resources may include grouped computing resource 1314 at data center infrastructure layer 1310. The resource manager 1336 may coordinate with resource orchestrator 1312 to manage these mapped or allocated computing resources.

In at least one embodiment, software 1332 included in software layer 1330 may include software used by at least portions of node C.R.s 1316(1)-1316(N), grouped computing resources 1314, and/or distributed file system 1338 of framework layer 1320. One or more types of software may include, but are not limited to, Internet web page search software, e-mail virus scan software, database software, and streaming video content software.

In at least one embodiment, application(s) 1342 included in application layer 1340 may include one or more types of applications used by at least portions of node C.R.s 1316(1)-1316(N), grouped computing resources 1314, and/or distributed file system 1338 of framework layer 1320. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1334, resource manager 1336, and resource orchestrator 1312 may implement any number and type of self-modifying actions based on any amount and type of data acquired in any technically feasible fashion. Self-modifying actions may relieve a data center operator of data center 1300 from making possibly bad configuration decisions and possibly avoiding underutilized and/or poor performing portions of a data center.

The data center 1300 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1300. In at least one embodiment, trained or deployed machine learning models corresponding to one or more neural networks may be used to infer or predict information using resources described above with respect to the data center 1300 by using weight parameters calculated through one or more training techniques, such as but not limited to those described herein.

In at least one embodiment, the data center 1300 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1200 of FIG. 12—e.g., each device may include similar components, features, and/or functionality of the computing device(s) 1200. In addition, where backend devices (e.g., servers, NAS, etc.) are implemented, the backend devices may be included as part of a data center 1300, an example of which is described in more detail herein with respect to FIG. 13.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1200 described herein with respect to FIG. 12. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
processing, using a first machine learning model (MLM), a first frame of a video to detect a first representation of an object in the first frame;
generating, based at least on the first representation, a first segmentation mask for the object in the first frame;
processing, using a second MLM, a second frame of the video and the first segmentation mask to detect a second representation of the object in the second frame;
generating, based at least on the second representation, a second segmentation mask for the object in the second frame; and
performing one or more operations based at least on the first segmentation mask and the second segmentation mask.

2. The method of claim 1, wherein the first representation comprises at least one of:
a bounding shape for the object in the first frame, or
a convex hull for the object in the first frame.

3. The method of claim 1, wherein the generating the first segmentation mask comprises:
applying a third MLM to a portion of the first frame associated with the first representation to identify at least a subset of pixels of the portion of the first frame corresponding to the object.

4. The method of claim 1, wherein the generating the first segmentation mask comprises redacting at least a portion of pixels of the first frame not associated with the object.

5. The method of claim 1, wherein the generating the second segmentation mask comprises:
estimating, using at least the first representation, a predicted representation of the object in the second frame;
updating, using the second representation, the predicted representation to obtain an updated representation of the object in the second frame; and
generating the second segmentation mask using the updated representation.

6. The method of claim 5, wherein the updating the predicted representation comprises applying a tracking filter to the predicted representation and the second representation.

7. The method of claim 5, further comprises:
processing, using the second MLM, at least a third frame of the video to detect a third representation of the object in the third frame; and
generating, based at least on the third representation and the updated representation, a third segmentation mask for the object in the third frame,
wherein the performing the one or more operations is further based on the third segmentation mask.

8. The method of claim 1, further comprising:
processing, using the second MLM, the first frame to detect a third representation of the object in the first frame, wherein the generating the first segmentation mask is further based on the third representation.

9. The method of claim 1, further comprising:
processing a first plurality of frames using at least the first MLM, the first plurality of frames comprising the first frame, and
processing a second plurality of frames using at least the second MLM, the second plurality of frames comprising the second frame,
wherein N consecutive frames of the video comprise:
a frame of the first plurality of frames, and
N−1 frames of the second plurality of frames, wherein N is an integer number greater than one.

10. The method of claim 1, wherein N is set in view of one or more of:
a frame rate of the video,
an amount of processing power available for execution of the first MLM.

11. The method of claim 1, further comprising:
processing a third frame of the video to determine that the object in the third frame is absent or occluded;
storing a segmentation mask generated for a frame preceding the third frame;
processing a fourth frame of the video to determine a fourth representation of a candidate object in the fourth frame;
generating, based at least on the fourth representation, a fourth segmentation mask for the candidate object in the fourth frame; and
determining, based at least on the stored segmentation mask and the fourth segmentation mask that the candidate object matches the object,
wherein the performing the one or more operations is further based at least on the stored segmentation mask and the fourth segmentation mask.

12. The method of claim 1, wherein the performing the one or more operations comprises:
generating, based at least on the first segmentation mask and the second segmentation mask, an annotation for the video.

13. The method of claim 12, further comprising:
generating, using a vision language model (VLM), a natural language description of at least one of:
the object,
a motion of the object, or
a type of action performed by the object;
wherein an input into the VLM comprises the video and the annotation for the video.

14. The method of claim 13, wherein the input into the VLM further comprises a natural language prompt associated with the video.

15. The method of claim 1, The method of claim 1, wherein the method is executed on a single graphics processing unit (GPU), and wherein a frame rate of processing the video is at least 15 frames per second.

16. A method comprising:
processing a plurality of frames of a video to obtain a plurality of representations of an object depicted in the video,
wherein a first subset of the plurality of representations is obtained by processing, using an object detection model, a first subset of the plurality of frames, and
wherein a second subset of the plurality of representations is obtained using visual similarity of an appearance of the object in a second subset of the plurality of frames to the appearance of the object in at least one frame of the plurality of frames; and
generating, using a vision language model (VLM) and the plurality of representations, a natural language description of at least one of:
the object,
a motion of the object, or
a type of action associated with the object.

17. The method of claim 16, wherein an individual representation of the plurality of representations comprises at least one of:
a bounding shape for the object in a corresponding frame of the plurality of frames, or
a convex hull for the object in the corresponding frame of the plurality of frames.

18. The method of claim 16, wherein the processing the plurality of frames of the video comprises:
generating a first feature vector associated with a first representation of the first subset of the plurality of representations, the first representation obtained by processing, using the object detection model, a first frame of the first subset of the plurality of frames;
generating a plurality of candidate feature vectors associated with a plurality of candidate representations for a second frame of the second subset of the plurality of frames; and
selecting a second representation of the second subset of the plurality of representations from the plurality of candidate representations, based at least on similarity of the first feature vector to individual candidate feature vectors of the plurality of candidate feature vectors.

19. A system comprising:
one or more processors to:
process, using a first machine learning model (MLM), a first frame of a video to detect a first representation of an object in the first frame;
generate, based at least on the first representation, a first segmentation mask for the object in the first frame;
process, using a second MLM, a second frame of the video and the first segmentation mask to detect a second representation of the object in the second frame;
generate, based at least on the second representation, a second segmentation mask for the object in the second frame; and
perform one or more operations based at least on the first segmentation mask and the second segmentation mask.

20. The system of claim 19, wherein the system is comprised in at least one of:
an in-vehicle infotainment system for an autonomous or semi-autonomous machine;
a system for performing one or more simulation operations;
a system for performing one or more digital twin operations;
a system for performing one or more medical operations;
a system for performing one or more factory operations;
a system for performing one or more analytics operations;
a system for performing light transport simulation;
a system for performing collaborative content creation for 3D assets;
a system for performing one or more deep learning operations;
a system implemented using an edge device;
a system for generating or presenting at least one of virtual reality content, mixed reality content, or augmented reality content;
a system implemented using a robot;
a system for performing one or more conversational AI operations;
a system implementing one or more large language models (LLMs);
a system implementing one or more vision language models (VLMs);
a system implementing one or more multi-modal language models;
a system implementing one or more language models;
a system for performing one or more generative AI operations;
a system for generating synthetic data;
a system incorporating one or more virtual machines (VMs);
a system implemented at least partially in a data center; or
a system implemented at least partially using cloud computing resources.
